(19) United States
(12) Patent Application Publication
(10) Pub. No.: US 2026/0090596 A1
(43) Pub. Date: Apr. 2, 2026

(54) GARMENT RECONSTRUCTION SYSTEM

(71) Applicant: Francisca GAJARDO CARREÑO, Santiago (CL)

(72) Inventor: Francisca GAJARDO CARREÑO, Santiago (CL)

(21) Appl. No.: 19/112,586

(22) PCT Filed: Sep. 16, 2023
(86) PCT No.: PCT/CL2023/050086

§ 371 Date: Mar. 17, 2025

(30) Foreign Application Priority Data
Sep. 18, 2022 (CL) 202202542

(51) Int. Cl. A41H 1/00; G06Q 10/30

(52) U.S. Cl. CPC A41H 1/00; G06Q 10/30

(57) ABSTRACT

Described is a garment reconstruction system comprising: a database containing the fundamentals and rules for transforming clothing; means for entering a series of user parameters, wherein the user can choose a garment from a list in the database; means for selecting transformations in the database, in combination with the set of rules of the invention, such that the user can choose which garment to produce; and means for providing a guide of possible results, such that the user can carry out the selected transformation.

### FIELD OF THE INVENTION

The present invention relates to the field of fashion and clothing, and more specifically to standardized manufacturing systems applied in the fashion industry.

### BACKGROUND

The fashion industry is one of the most polluting industries worldwide, and its overproduction and overconsumption are driving the planet to its limits. It corresponds to a linear economy, and the most polluting stages of its supply chain are:
1. Design: Where the decisions that will be carried out in the rest of the chain are made. These decisions are responsible for the environmental and social impact that is generated in the following stages. It is said that 80% of a product's impact can be avoided at the design stage. In this stage, the silhouettes of the collections are decided, which will then shape the patterns or molds of the garments, as well as the materials that will be used.
2. Materials: This stage can include the extraction of natural resources, chemical processes of these resources, spinning, and fabric manufacturing. In 2018, the fashion industry generated 2 billion tons of CO2. The materials stage is responsible for 61% of that impact.
3. Manufacturing: In this stage, the pattern making, cutting, and sewing of the garments are carried out. The pattern or mold is a 2D planimetric drawing based on standard body measurements. This pattern is placed on the fabric and its shape is cut out, leaving scraps or remnants. Studies estimate that 15% of the fabric is wasted in this process. In many cases, the social impact generated by sewing is reflected in modern slavery suffered by third-world countries exploited by large retail companies. These people with great sewing skills are forced to work for wages below poverty levels in order for companies to lower costs and generate greater profits.
4. Promotion and Sale: In these stages, one can see the impacts of overproduction and overconsumption on our environment, and the psychological impacts that the market has on people to maintain the toxic relationship between supply/demand, buying cheap, buying a lot, and disposing of items unscrupulously.
5. End of the product's life: This is when the garment ends its cycle in illegal clothing dumps, its illegal burning, in places such as Africa and the Atacama Desert. It is estimated that the equivalent of one (garbage) truck full of clothing is incinerated or sent to landfills every second.

In this regard, it is possible to point out that there are some solutions related to the problem of the referred field of the invention, both nationally and internationally.

In particular, document CL199400104 refers to an improved procedure applied to the use of structured molds for cutting and sewing, which basically consists of obtaining a unified mold in which the continuous lines represent the outlines of the front piece and the segmented lines represent the outlines of the back piece, potentially using an auxiliary pattern to trace the pronounced curves of the fly, the inseam, and from the knee to the fly, when trousers are made.

Likewise, in document KR102353776B1, a system and method are disclosed for superimposing and/or deforming a three-dimensional polygonal garment mesh for garment fit visualization. The deformation engine receives at least one garment mesh installed on the template's body mesh and transforms the garment mesh into a target body mesh according to a geometric deformation algorithm. The layering engine receives a plurality of clothing meshes individually installed on a target body mesh, and according to an iterative layering process, transforms each individual clothing mesh according to the layer order while avoiding intersections among other clothing meshes and the target body mesh.

On the other hand, in document U.S. Pat. No. 10,964,078B2, a system, device, and method of image processing are also described, particularly using machine learning and computer vision. A user selects a particular shirt from an online catalog; and instead of seeing an image of the shirt on the shelf or being worn by a model, the system generates and displays for the user an image of that particular shirt being virtually worn by that specific user. The user requests the system to show search results for blue pants; and instead of producing generic images of blue pants, on the shelf or worn by various models, the system generates user-tailored search results that show several types of blue pants virtually worn by the user themselves, or virtually worn by another specific person selected by the user. The system enhances the product image by correcting and adding realistic-looking shading and wrinkles.

In document US20080307556A1, reference is made to new methods of recycling clothing. Although the concept of recycling garments is not new, the new methods and the results of these methods are new and unexpected. Rarely is garment recycling as practical and easy as the methods to be presented. Furthermore, these recycling methods can allow clothing manufacturers, sewing boutiques, and even domestic sewers to save money and time. The benefits include sewing as little as possible while giving the impression that a great deal of sewing has been done. Another advantage includes the possibility of recycling garments that did not pass quality control inspections due to slight imperfections. By using the new methods, a marketable children's clothing line can emerge from what would normally be a loss. Consider the benefits of a new children's clothing line that is almost entirely sewn before the new recycling methods begin.

According to US20180255853A1, a system for producing, measuring, combining, and sizing fabric, garments, and bags is described, with the aim that it can be completed by any individual, making each garment, clothing item, and bag unique, by using a size and design determination system according to each person's body type and uniqueness. The system is composed of garment pieces, garment parts, garments, fabrics, and bags, and is intended to meet each person's needs, while being characterized by a system for combining changes, exchanges, lengthenings, replacements, shortenings, expansions, moves/subtractions, extensions, transformations, and modifications, with the connections of garment parts and/or fabrics detaching, and therefore being used simultaneously in any change. Due to the present invention, each type of garment is adapted to more user needs, resulting directly, first, in the creation of parallel and multiple clothing options, and second, in saving the cost of purchasing a complete garment, since the user, according to the invention, purchases pieces or parts of a garment.

Also, in EP1595465A1, a method for computer-assisted clothing design is described, which includes the following steps: a) providing, via computer, at least one garment template (13) composed of a basic three-dimensional surface, personified by an enveloping body cover (2). The aforementioned garment template (13) must be defined using parametric coordinates. b) Adapting, via computer, the garment template (13) to the aforementioned body (2) by loosening and/or tightening different selected areas (15) of the garment template (13) relative to the body (2), according to the desired design. c) Cutting and removing, via computer, selected areas of the garment template (13) in accordance with the aforementioned desired design. Additionally, it includes the possibility of applying textures and color attributes to the garment template and digitally animating the body (2) along with the garment template (13). It also includes an additional step for designing through computer-generated patterns from the information defined in the garment template (13), modeled according to the desired design.

### Sustainable Fashion:

In recent decades, the industry has sought to address these critical points in its chain and transition to a more circular economy through the following methods.
a. Bio-Materials (at the Design stage): Materials developed from plants, food, algae, etc. For example: Leather made from mango peels. These solutions are optimal, as the end of the product's life can be composted, thus becoming a nutrient for nature. What is extracted is merely borrowed, to then be returned and regenerate the Earth. The main issue with these technologies is that there are still no biomaterials that can be integrated into the fast fashion supply chain, nor the possibility of offering them as products other than luxury items (for the time being). In other words, it is not an immediate possibility for the masses.
b. Zero Waste: The concept of Zero Waste or “Residuo Cero” is widely applied to industry solutions. For example, how to maximize the use of chemicals, gases, or steam from industries and utilize them in other stages of the supply chain. Notably, for this patent proposal, there is the “Zero Waste Pattern Cutting” or “Patronaje Residuo Cero” technique in the design and manufacturing stage. This methodology consists of developing patterns that, when cut on fabric, do not generate waste. The patterns are fitted, adapted, and redesigned so that they tessellate perfectly, leaving no empty spaces between them. The entire piece of fabric is used.
c. Recycled Fibers: Garments of the same composition are collected and processed to revert them into yarn. For example, recycled polyester or nylon. Although garments are recycled and kept out of landfills, this process consumes a great deal of energy, and it cannot be applied to garments that have a mixed composition, such as polyester/cotton, nylon/spandex, etc.
d. Upcycling: This technique involves the reuse of materials that are out of use or considered waste, transforming them into something new of the same or greater value. It is a fairly broad term and can be applied to everything from repurposing plastic bottles into plant pots, pallets into furniture, car tires into backpacks, nuts and bolts into necklaces, pots into lamps, cassettes into storage boxes, and so on-limited only by creativity.
e. In the textile field, there is also a wide range of ways to implement upcycling—for example, transforming garments into accessories, garments into other garments, repurposing fabric scraps or deadstock fabric into new garments, using scraps for home goods or upholstery, converting curtains into tunics, turning bedspreads and sheets into coats, and so on.
f. The advantage of this method compared to those mentioned previously is that by reusing, we do not generate the energy consumption that occurs in recycling, since we are using the material as it is, without processing it back to its origin (for example, melting plastic bottles to create pellets, then thread, then fabric, and so on to produce garments). Also, compared to recycling, we can reuse textiles with mixed compositions and create new projects without discriminating by fiber.
g. Compared to biomaterials, upcycling can be considered an optimal application for this decade, since there are many materials regarded as waste and it can be practiced immediately by numerous people; it does not require extensive technology, laboratories, or studies to implement-only manual skill and creativity.
h. Now, regarding the Zero Waste system, it always uses new or recycled fabric to apply the cutting and pattern-making system, whereas upcycling can work with discarded fabrics, scraps, and garments that are unused or discarded. The drawback is that in the processes of design, cutting, and sewing based on upcycling, previously selected patterns are often used to extract only what is needed from the material, thus generating waste (for example: turning an unused dress into shorts involves placing the shorts pattern on the dress and extracting only what is necessary, generating waste during cutting).
i. Another disadvantage of upcycling is that there are not enough resources available on how to apply it on an industrial and/or rapid scale, especially for unused garments.

Based on the previous analysis, the issue to be addressed is how to use the most accessible method (upcycling) and improve it in its weak points (Zero Waste and scalability in garment reuse)

### DETAILED DESCRIPTION OF THE INVENTION

The invention comprises a garment reconstruction system that does not generate waste in the transformation process, in which no molds or patterns are used, but rather a sizing system based on a database that will allow it to be scalable, standardized, and reproducible on a large scale, as well as a platform and related methods (FIG. 1-FIG. 4).

The proposed invention is a methodology for garment reconstruction that consists of sets of rules, base pieces, and standardized sequences, supported by a theoretical framework that also includes the application of an algorithm, which addresses the issue of converting and reusing existing clothing and apparel without generating waste and enabling the creation of new garments from other existing ones. In most cases, these base pieces are the original patterns of the garment, including a reinterpretation of the curves and straight lines of the molds, allowing them to be readapted for transformation to other bodies. For example, the reinterpretation of the crotch curves (the inseam curve), the armholes (the armpit curves), the sleeve cap (the upper curve of the sleeve that looks like a bell), collars, and so on, where each body curve accommodates a new repositioning to thus initiate a new body. The same applies to straight lines such as shoulders, sides, and hems.

In one embodiment of the invention, the proposed invention's system will enable waste-free garment reconstruction into multiple design possibilities in a rapid, systematic, and scalable manner, constituting an optimal and cost-effective solution for the fashion industry and a regenerative option for the environment.

In another embodiment of the proposed invention, the database and sizing system of the proposed invention will allow, for example, the user to decide, based on a wide variety of design possibilities, on the target garment into which they wish to transform their waste, as well as the step-by-step methodology for achieving that objective.

In another embodiment, the system of the invention consists of the disassembly or unstitching of the garments to be reused, to create a sort of puzzle through the reinterpretation and repositioning of the base pieces that make up the original garments, thereby obtaining another practical and traditional body in a standardized manner.

The invention enables both transforming an original garment (based on the parameters of the corresponding original garment, for example: length, width, fabric type, number of zippers, type of collar, type of waistband, hem measurements in centimeters, inseam and armhole lengths, number and measurements of pockets, type of fabric, number and measurements of darts, and any other relevant parameters of the garment) into any of the garments present in the list of transformations in the database, as well as performing a desired transformation and indicating to the user/external system which garments will be needed to carry out said transformation. In this way, the system allows for reusing clothing that is no longer wanted, useful, or necessary, into something necessary and useful in the user's present; and additionally, it will allow teaching the user or an in silico system of any industry in the field of apparel and clothing methods to transform a target garment, starting from one or a series of garments that can be used as raw material to achieve the desired final result, providing different pathways or transformation variants, so that the user can choose the one that best suits or fits their needs. This last method is particularly relevant in the industrial field, as it would allow for reducing the stock of garments or leftover items from previous seasons, transforming them into new seasonal garments, as well as designing new models which, when entered into the database, the system can find different options within the invention's methodology to achieve the expected result

In one embodiment of the invention, the system comprises a selection method that allows the user, through the system's platform, to enter the data of a particular garment they wish to convert, so that the system can propose a series of possible transformations or, once the user has decided to carry out a desired configuration or transformation based on their garment, the system can indicate whether the transformation selected by the user is feasible. If that is the case, the system will provide and guide the user through a series of steps, which also includes guides, manuals, image sequences, instructions, and recommendations, so that the user can carry out the desired transformation; finally, the system will collect information corresponding to the transformation performed, in order to evaluate and validate the transformation, effectiveness, and/or efficiency of the process, as well as any other parameters necessary to determine the success of the process.

In another embodiment of the invention, if the user is not certain which garment they wish to convert or transform, but is certain about the target garment they wish to obtain, the system comprises a second method to guide the user in selecting the target garment or final garment to be obtained, and once confirmed by the user, the system also provides the user with a series of probable and feasible options to obtain said garment, from different initial garments to be transformed. Once the user has decided and selected which initial garment will ultimately be used to achieve the desired result, this second method will guide the user through the system's resources, including the information and components in the database, to provide a step-by-step guide for carrying out the desired transformation. As in the previously described method, the system includes a transformation evaluation process, which will allow the incorporation of the results and parameters into the system to modify and improve the transformation processes, using the user's feedback and the performance of the process.

### Elements of the Invention

The invention comprises various elements that are relevant for developing the invention, including:

### 1. A Sizing System Based on a Database:

A database will be developed on the basis of measurements, cuts, shapes of garments, step-by-steps, of garment transformation where the transformations will be organized on the basis of the size of the garment that is recycled and what that garment can come to be on the basis of that size. Also vice versa, a desired design in a specific size and with which garments in which sizes one can arrive at that desired design. This sizing system will not require the use of molds or patterns and therefore, no waste will be generated.

### 2. Transformation Variables of the System of the Invention:

There will be different categories of how these transformations are organized, which will allow the user who utilizes the system to choose a garment and the system will deliver guided instructions to achieve the suggested transformation from different options of garments included in the database, using at least 95% of the base garment(s), to transform it into the desired garment. The system also comprises methodologies that allow the user to enter parameters of one or several garments from which the user can identify possible transformations derived from each of said garments or any combination thereof, using at least 95% of the garments entered by the user, to achieve the transformation suggested by the system and/or selected by the user.

Among the transformation variables that the system comprises, the following are included:
2.1 By Subtraction: The system has strategies to identify the parts of a garment that can be subtracted to facilitate the creation of another pattern. This will require an understanding of the different garment patterns and how they can be modified, and the analysis of the key parts of the patterns that, when extracted in one way, can initiate a new pattern.
In this case, they will correspond to specific cuts in the garment based on curves which will initiate its future transformation. Example: From an open sleeve, a specific piece is extracted that will form the front rise and back rise, thereby generating the beginning of the construction of a pair of pants. The rest of the pieces from which the sleeve was obtained are rearranged in a specific way to arrive at the pants (FIG. 5).
2.2 By Individual Reconstruction: The system includes a guide that helps the users to understand how to transform one garment into another, taking into account the type and the quantity of available fabric and the desired final product.
In this case, it comprises the complete disassembly of a garment to arrive at one or more garments. The complete garment is unstitched and the pieces are rearranged to arrive at another garment without generating waste in the process. For example: A pair of pants is disassembled, its pieces are rearranged and a pair of pants is arrived at (FIG. 6).
2.3 By Multiple Composition: The system has strategies to combine multiple garments into one. This also implies combining different types of fabric or incorporating different design elements from each garment.
In this case, two or more garments are disassembled, so that by rearranging the pieces of these a garment can be composed. For example: A pair of pants and a skirt are used to assemble a jacket, and an extra pair of pants is included for the lining of the jacket (FIG. 7).

### 3. Implementation of the System of the Invention

3.1 Formulation of relations: The system has mathematical relations between the dimensions of different parts of the body: the torso, the legs, and the arms. This is expressed as proportions or ratios that can be used to change the size or remodel the pieces of fabric.
3.2 Calculations of material efficiency: The system has formulas that calculate the most efficient way to use materials when transforming a garment. For example, if pants are converted into a garment of the upper body, the system calculates the best way to place and cut pieces to minimize waste.
3.3 Scaling algorithms: The system has algorithms to scale garment pieces up or down based on the fractal proportions of the body. These are used to adapt a pattern to different sizes or body shapes.
3.4 Pattern regeneration:
   3.4.1 Rules for reinterpretation of patterns: There are established rules to convert one type of garment into another. For example, how to convert the legs of the pants into a torso or the arms into a torso. This includes where to place curves, darts, or seams.
   3.4.2. Steps of reinterpretation of patterns: Step-by-steps that follow these rules and can be easily used for the reconstruction. These guides and transformations are based on the fractal proportions of the body and/or on the body proportions of the person.
3.5 Technological integration:
   3.5.1 Transformation software: The software tool that can automatically generate reconstructed designs based on the mathematical formulas. This tool will take as input the type of garment to be reconstructed and the person's measurements, and will output a customized pattern for the reconstruction. Or it can take the desired design as an outcome, and offer the clothing that needs to be reconstructed to get there.
   3.5.2 AR/VR Applications: Augmented Reality or Virtual Reality will be used to visualize the final garment before the reconstruction begins. This technology will show how the pattern replacement will look once it is sewn, helping to avoid errors and reduce waste.
   3.5.3 A1 Integration: The integration of AI in the garment reconstruction system will significantly improve its efficiency, accuracy, and scalability. Here are some ways in which this will be applied:
   a. The role of AI:
      i. Predictive analysis: AI will use the system's historical data to predict future outcomes. It will estimate the potential success of a garment transformation, evaluating factors such as material compatibility or design viability.
      ii. Recommendation systems: AI will analyze the behaviors, preferences, and attributes of the users' garments to suggest possible transformations or reconstruction designs.
      iii. Image recognition: AI, through neural networks, will categorize the images of the garments, recognizing patterns, colors, or types of fabrics without manual input.
      iv. Automated measurement extraction: We will integrate advanced AI models that can potentially measure lengths, widths, and other specific characteristics of the garment from uploaded images, reducing the manual data entry.
   b. Data collection and organization:
      i. Data collection: AI is nourished by data. Our database will be extensive, well-organized, and rich for effective AI integration. The system's garment database is the primary source. We will consider collecting user reviews, transformation successes/failures, and user preferences.
      ii. Data preprocessing: The data will be consistent and uniform. We will handle missing values, eliminate outliers, and normalize values for better training of the model.
   c. AI Model:
      i. Deep Learning: Convolutional neural networks (CNN) for image recognition tasks. They process images in layers to identify patterns and characteristics.
      ii. Recommendation systems: Collaborative filtering recommends based on similar user preferences, while content-based filtering recommends based on the garment's attributes.
   iii. Regression models: They predict numerical values, such as the potential percentage of material waste during a reconstruction.
   d. Model training: It will provide the model with a subset of our data, known as the training set. It will learn patterns, relations, and characteristics from these data.
   e. Evaluation and testing: It will use a separate set of data (test set) that the model has not seen before, and we will measure its performance metrics such as accuracy, precision, recall, etc. This will give us an idea of how well the model will work in real-world scenarios.
   f. Application: Integration of the trained AI model into our system. This will require technical integration, ensuring that the model interacts seamlessly with the frontend and the backend of our system.
   g. Continuous learning and updates: The AI will not be static. It will regularly update the model by retraining it with new data. User feedback, new garment data, and transformation results can be valuable for this.
   h. User interface and interaction: It will be ensured that the AI features are easily accessible. For example, an image upload feature will be intuitive, with clear instructions. The recommendations will be clearly displayed, with visual aids or diagrams.
   i. Feedback loop: Users will provide feedback on the AI suggestions. Was a recommended transformation successful? Were the predicted results accurate? This feedback will refine the AI learning.
   j. Ethics and privacy: We will always be transparent about the use of data. It will guarantee strong data protection measures, and users will be informed about how the AI uses their data and for what purpose.
   k. Scalability: As our system grows, the amount of data and user requests will increase. It will opt for scalable AI solutions, considering cloud options or dedicated servers.
   l. Benefits of the integration of AI:
      i. Efficiency: Automated processes mean faster results.
      ii. Precision: AI can provide consistent and precise recommendations.
      iii. Personalization: AI can offer personalized recommendations based on the user's preferences or past interactions.
      iv. Scalability: It can handle large volumes of data and requests Scalability: It can handle large volumes of data and requests.
   j. Education and training:
      i. Guides and manuals: The system will provide detailed guides and manuals that explain the mathematical formulas and how they are applied in the reconstruction process. This will include diagrams and examples to help users understand.
      ii. Workshops and tutorials: It will conduct workshops and/or create online tutorials that will teach people how to use the mathematical formulas and the pattern templates to reconstruct their garments.

This approach is unique because it combines an understanding of human body proportions with mathematical principles to create a scientifically grounded method for garment reconstruction. It not only adds a level of precision to the process, but it also ensures material efficiency, which is key to achieving zero waste.

### 4. System Fundamentals

Behind these categories and this system there exists a foundation, in which the methodology corresponds to an innovation supported by the fractal geometry identified in the body. This type of geometry consists basically of self-similarities and iterations. It consists of families of self-similar forms that repeat or fragment at different scales.

By studying the possible adaptations of the pieces resulting from the disassembly of garments (pieces that were previously cut, in their original construction, with fabric molds), a single essential form is identified that is capable of moving, readjusting, and adapting to the body. A single essential form that can act as a body, as legs, as arms, as a head. Everything depends on the sizings with which one works and the fabrics of the garments. This form acts like a spiral around the body, readapting itself around it (FIG. 8).

Although the proposed system does not use molding or patterns, it should be noted that the garments when they were created (before coming to be reused) were indeed made based on patterns. The body is the mold itself (FIG. 9).

Furthermore, although the form that is repeated throughout the body is not exactly the same in arm, leg, and body (because they are wider, narrower, or fitted), they can be considered within the fractal parameter, and adapted by means of darts, lengthenings, and specific cuts. Thus, the entirety of the reused garment is taken advantage of to generate another garment. The scheme would always consist of bodies being arms and/or arms being legs and/or legs being body, and so on until necks and heads are considered (FIG. 10).

### 5. Bases and Proportions

Although the details of these formulas would need to be developed through adjustments and experimental adjustments to take into account the complexity and variety of forms and sizes of the human body, we can outline a basic conceptual framework for such formulas:
5.1. Width Relations:
   5.1.1. Trunk circumference=circumference of 2 legs (or) circumference of 2 arms.
   5.1.2. Leg circumference=circumference of one arm.
5.2. Relations based on width (circumference):
   5.2.1. T=Trunk width.
   5.2.2. L=Width of one leg.
   5.2.3. A=Width of one arm.
   5.2.4. Formulas:

$$i . T \approx 2 L ;$$

$$ii . T \approx 2 A ; and$$

$$iii . L \approx A .$$

5.2.5. Interpretation:
   Where the trunk width is approximately equivalent to the combined width of two legs or two arms; and where the width of one leg is approximately equal to the width of one arm.
5.3. Length Relations:
   5.3.1. Trunk length+extra length≈leg length.
   5.3.2. Leg length>arm length.
   5.3.3. Trunk length≈arm length.
5.4. Relations based on length:
   5.4.1. TL=Trunk length.
   5.4.2. LL=Leg length;
   5.4.3. AL=Arm length;
   5.4.4. Formulas:

$$i . TL < LL ,$$

$$ii . TL \approx AL , and$$

$$iii . AL < TL .$$

5.4.5. Interpretation:
Where the trunk length is less than the leg length; where the trunk length is approximately equivalent to the arm length; and where the arm length is less than the leg length.

The relations now clearly demonstrate that:
i) The trunk, when opened, can approximately match the combined widths (circumferences) of two legs or two arms;
ii) A single leg, in width, is somewhat similar to an arm, but is longer; and that
iii) The trunk length is approximately equal to the arm length.

This helps to create a system of interrelationships among the different sections of the garment, which allows for various possibilities of reconstruction based on the dimensions of the garment.
5.5. Other relations
If we define body as C, Leg as P, and arm as B, we can define the following relations:
   5.5.1. C=P=B for the base theory, but conditioned by sizing
   5.5.2. 1C=2 (P−l), where l=length difference between body and leg
   5.5.3 If we wanted to subdivide a gabardine, for example, we have to assume that this garment has:
      i) LENGTH TC_{L}
      ii) WIDTH TC_{W}
         Divide the Gabardine into Two Pieces-Upper and Lower:

To simplify, we can divide the gabardine into two equal halves. This may not be the case in all practices, depending on the design of the skirt and the jacket, but it is a starting point. The proportions can be adjusted based on the desired final designs.

### Jacket (Upper Half) Dimensions:

$$iii ) LENGTH {J}_{L} = 0.5 \times {TC}_{L}$$

$$iv ) WIDTH {J}_{W} = T {C}_{W}$$

### Skirt (Lower Half) Dimensions:

$$v ) LENGTH {S}_{L} = 0.5 \times {TC}_{L}$$

$$vi ) WIDTH {S}_{W} = T {C}_{W}$$

### 6. Transformation Relations:

We also have mathematical reasons to complement the reconstructions.
6.1. 1:1 (One garment into one garment): Techniques to transform one garment into another, with minimal or no waste. This will involve deconstructing and completely remaking the garment.
6.2. 1:2 (One garment into two): This shows users how to divide a single garment into two separate pieces. This could be useful for transforming larger garments into smaller ones, or for creating matching sets.
6.3. 3:1 (Three garments into one): Techniques of the process of combining three different garments into one. This could involve mixing and matching different parts of each garment to create a new and unique piece.
6.4. 1: 1/x (One garment into fractions): To demonstrate how to divide a garment into several parts that can be used separately. This could be useful for creating accessories or for using the fabric in other sewing projects.

The proposed invention system promotes both creativity and sustainability, allowing users to give new life to old clothes and reduce waste. Providing specific examples and tutorials for each category and transformation relation will facilitate users' understanding and application of these techniques.

It is also important to remind users that each transformation may not result in zero waste, but the goal is to minimize waste as much as possible. This could involve finding uses for any leftover piece of fabric, such as pillow stuffing or material for smaller sewing projects.

### 7. Rule Set of the Invention System

Clear, step-by-step explanations of the invention system, in which, for example, the trunk can be legs, the legs can be body, the body can be arms, the arms can be body, the arms can be legs, the legs can be arms, body adaptation, sliding along the Y-axis, etc., as detailed below:
7.1 Transformations of the Trunk:
   7.1.1. Trunk to Legs: Guidelines for transforming the fabric of the trunk of a garment into a pair of legs. Include instructions to adjust the width and length of the fabric to fit the dimensions of the legs (FIG. 11).
   7.1.2. Trunk to Arms: Likewise, instructions will be provided to transform the trunk into arms. As mentioned previously, the guidelines will include adjustments for the width and length to achieve the desired dimensions (FIG. 12).
7.2. Transformations of Legs:
   7.2.1. From Legs to Trunk: Step-by-step guidelines will be provided to show how the legs of a garment can be transformed into a trunk. This will include how to adjust the length and width of the leg fabric to create a comfortable trunk fit (FIG. 13) (INVERSE OF TRUNK TO LEGS).
   7.2.2. From Legs to Arms: There will also be instructions to guide users on how to transform the legs of a garment into arms. Once again, the guidelines will include how to adjust the fabric so that it fits the size of the arms (FIG. 14).
7.3. Transformations of Arms:
   7.3.1. From Arms to Trunk: Provide guidelines on how to transform the arms of a garment into a trunk, including adjustments for width and length to create an adequate trunk fit (FIG. 15). (INVERSE OF TRUNK TO ARMS-FIG. 12)
   7.3.2. From Arms to Legs: Likewise, there will be guidelines on how to transform the arms of a garment into legs, with adjustments for width and length to fit the dimensions of the legs (FIG. 16). (INVERSE OF LEGS TO ARM-FIG. 14)
7.4. Body Adaptation:
These rules will guide users on how to alter the size of a garment to fit different body shapes and sizes. This will include adding or reducing the width, length, and other adjustments to ensure a comfortable and flattering fit by sliding along the Y-axis. This refers to the vertical adjustments that may be necessary when transforming a garment (FIG. 17).
For example, when converting pants into a top, it may be necessary to shorten or lengthen the garment along the Y-axis to achieve the desired length. The guidelines will include how to make these adjustments while minimizing waste and maintaining the integrity of the garment.
The Body Adaptation Rule embodies the essence of reimagining garments through strategic positioning, whether vertically (along the Y-axis), horizontally (along the X-axis), or through rotation. This versatile technique paves the way to create various ensembles from a single garment, emphasizing a zero-waste design philosophy by incorporating remnants from the adaptation process into the new design as elegant finishing touches.
Principle: Each garment, regardless of its initial design, has a latent potential. Through shifts, slides, and rotations, its form and function can be transformed, unlocking a great number of new tailoring opportunities. Some of these are as follows:
   7.4.1 Vertical Adaptation (Y-Axis): Transforming a T-Shirt: Start with an oversized t-shirt. By sliding it upward so that the neckline rests on the chest, the excess length can form a mini dress. The remaining remnants will be finished and used as straps.
   7.4.2 Skirt Adaptation: Slide the t-shirt further down, placing the neckline at the waist or hips, to create a layered skirt.
7.5 Subdivisions

Each garment, regardless of its size, can be considered a canvas of possibilities. Its length and width can be divided, and each resulting segment can be reinvented into distinct sections of a new ensemble, such as tops, bottoms, or sleeves. Example: A long dress or a long t-shirt can be divided around the waist or hips, creating a matching blouse and skirt ensemble. Alternatively, a shorter shirt can be used as the lower part, and with the remainder, an upper part can be created (FIG. 18).
7.6 Skirts as Adapters for Appendages: Arms and Legs
Skirts, due to their structure and versatility, can serve as a fundamental element in the construction of covers for arms and legs. Their inherent tubular design aligns with the anatomical shape of our limbs, making them the primary candidates for innovative reconstructions (FIG. 19).
7.7. Pants as Expanders: Using One Leg to Increase Width
Pants, by design, encompass two cylindrical legs that offer substantial material. One leg can be strategically deployed to provide additional width, either to adapt to the changing dimensions of the body, to incorporate a stylistic flair, or to restore worn garments (FIG. 20).
7.8 From Body to Hood: Reconstructing Small Trunks
Fashion, in its essence, is about seeing the potential in the ordinary. One such example is recognizing the adaptability of smaller body garments (or trunks) and their latent potential to become functional and elegant hoods. Smaller trunk garments inherently have a curvature and width that lend themselves well to the structure of a hood. By creatively reorienting and restructuring specific sections of the garment, it can be effectively transformed into a hood with minimal waste (FIG. 21).
7.9 Dart Mastery: Transition Between Rectangular and Curved Forms
Rectangular pieces of fabric can be adapted to fit curved patterns by strategically adding multiple darts. Conversely, curved pieces can be reverted to a more rectangular shape by eliminating or redistributing these darts. This ability is crucial when adapting remnants for the finishing touches or when customizing the fit (FIG. 22).
7.10 Sleeve Adaptation: Converting Rectangles into Sleeves
A rectangular piece can be remodeled to fit the more curved shape of a sleeve head. This is achieved by cutting along a defined diagonal and adjusting the resulting pieces (FIG. 23).
7.11 Every Scrap Is a Design Opportunity
Instead of perceiving leftover pieces of fabric as waste or byproducts, we see them as unique opportunities to enhance, decorate, or even functionally transform a garment.
7.12 Transformations and Size: A Delicate Balance
Introduction: In the dynamic world of garment reconstruction, every decision made-whether it is a cut, a design alteration, or the merging of fabrics-directly affects the final size and shape of the clothing. Although transformations provide new life and style to garments, they often bring changes in size and fit.
Key Principles:
   i) Every Cut and Body Adaptation Reduces Size:
      Essence: Every time a garment undergoes a cut or is adapted to the body's contour, it invariably loses part of its original size. Whether it is the removal of fabric during the adaptation or the natural constriction that occurs during fitting, size reduction is a typical outcome.
      Implication: Designers must be aware of this inherent size reduction, especially when working with limited material or seeking a specific fit.
   ii) Reversion After Transformation Is a Challenge:
      Essence: Once a garment has been transformed, returning it to its original size or shape becomes a complex task. The nature of the cut and sewing often means that material is lost or irreversibly altered.
      Implication: Transformation decisions must be made with foresight. It is crucial to visualize the final result and be certain of the design options, understanding the permanence of each change.
   iii) The Combination of Garments Increases Size:
      Essence: When garments or pieces of fabric are combined, it naturally results in an increase in size. This can be used creatively to design large-sized pieces, layering elements, or to introduce volume.
      Implication: This principle provides the opportunity to counterbalance the size reduction from cuts and adaptations. By strategically combining materials, designers can achieve a desired size and shape.
7.13 Interchangeability of 3D Curved Forms
Premise: The naturally curved areas of the body, such as the bust, the head, and the shoulders, have distinct but similar 3D geometries. This allows for versatile design possibilities.
   i) Unified Geometry: Bust cups, hats, and shoulder pads share inherent curvatures. Recognizing this similarity opens avenues for interchangeability.
   ii) Reuse Through Readaptation: Understanding these shared curves allows designers to creatively reuse them. For example, the curvature of a shoulder pad could align with that of certain hats or bra cups.
7.14 Triangular Openings to Create Darts
The inherent design and shape of certain sections of a garment, such as the collar of a blazer, can be reused to create structured fittings in new designs such as a bust top or a type of bra. Furthermore, any triangular opening in the clothing has the potential to function as a dart, facilitating a contoured fit (FIG. 24).

This set of rules essentially forms the instruction manual for our system. The objective is to ensure that even beginners can follow the guidelines and successfully transform garments. We will use visual aids such as diagrams, photos, or videos to accompany the written instructions. This will result in the process being easier to understand and follow, especially for complex transformations.

### 8. Transformation Process Through the System of the Invention

The transformation process will be complemented with examples of it at each stage, including: images of the clothing (before and after), the weight, and the step-by-step transformation with images or written guides, from undoing to cutting, sewing, and the final result. Multiple examples and variations. Also including a validation of the process, using, for example, the weight of the design at the end to evaluate the percentage of upcycling.

Thus, the process comprises the following steps:
8.1. Initial Images (PHOTOS BEFORE): We begin with clear and well-lit images of the original garment. Show it from multiple angles, if possible, to provide a complete view of the starting point. This will provide a visual reference of how the garment looked before the transformation process.
8.2. Weight Measurement: We weigh the original garment and record the weight. This step is crucial for calculating the percentage of upcycling later.
8.3. Deconstruction Process: We disassemble the garment to its essential patterns. We document the process of what needed to be undone from the original garment. This could include photographs or videos that show how to carefully remove the stitches and separate the garment into its constituent parts.
8.4. Cutting Process: Similarly, we document the cutting process of the pieces of the garment according to the transformation formulas and rules. This will also include images or videos to help users follow.
8.5. Sewing Process: Once the pieces are ready, we document the process of sewing them together again to create the new garment. Once again, we will use photographs or videos to provide clear step-by-step instructions.
8.6. Final Result: We show the complete garment with images from multiple angles. We make sure to include any important detail or feature of the new garment.
8.7. Final Weight Measurement: We weigh the complete garment and record the weight.
8.8. Calculation of the Upcycling Percentage: We calculate the percentage of upcycling by comparing the weight of the complete garment with the weight of the original garment. This will provide an indication of how much of the original material was used in the transformation process.
8.9. Lifecycle of the New Reconstructed Design: A study and analysis is conducted on the impacts and consumption that this new design had in terms of energy and CO2 emissions.

By providing multiple examples and variations, the system will demonstrate its versatility and inspire users to experiment with their own garment transformations. As much as possible, we will ensure that the instructions and examples are easy to follow, even for beginners. Additionally, we will show transformations that involve different types of garments and fabrics to demonstrate the wide range of possibilities offered by the system.

### 9. Conversion Size Table:

The present element of the invention will show what size of garment will be obtained according to the size of the garment being reconstructed and based on the zero-waste transformation (rule) chosen by the user.

Thus, the Conversion Size Table is an essential tool for the system; wherein said table will provide users with a clear and easy-to-use guide to help them understand how the size of the original garment can affect the size of the reconstructed garment, depending on the type of transformation chosen, including the following parameters:
9.1. Original garment size: Begin with a column for the size of the original garment. This could be expressed in standard clothing sizes (S, M, L, XL) or in numerical sizes, depending on the user's preference and familiarity.
9.2. Type of transformation: Each type of transformation offered must have its own column or section in the chart. The transformations could be listed according to the transformation categories described (for example, subtraction transformations, individual reconstructions, multiple compositions).
9.3. Resulting garment size: Under each type of transformation, list the expected size of the resulting garment for each size of the original garment. This can be given in the same size format used for the original garment size.
9.4. Notes and adjustments: Provide a space for any additional notes or adjustments that may be necessary for each transformation. This could include tips for altering the size if the resulting garment is too large or too small, or notes on how different fabrics or garment styles can affect the size.

This chart or Conversion Size Table will help users better anticipate the outcome of their transformations, increasing their chances of success and satisfaction with the process. It will be easy to read and understand and, ideally, should also be visually appealing.

Clothing sizes can vary widely between different brands and regions, so the table will be as adaptable and inclusive as possible. It will also provide a guide on how to take accurate body measurements to help users determine their correct size (FIG. 36).

### 10. Database:

Another component of the invention corresponds to the integrative and dynamic database, which will gather the basic information necessary to perform the transformations, feed the algorithms, and create systematization. The database will operate with form categories such as: i) “Tops” for all clothing that goes on the upper part of the body, ii) “Bottoms” for all clothing that goes on the lower part of the body, and iii) “Whole” for clothing that includes both the upper and lower parts.

Additionally, said database will include subcategories such as: all known types of tops in industrial pattern making, all known types of bottoms in the same area, and likewise for all types of ensembles. The database will also include a series of variables to store parameters such as: garment weight, composition, brand, material name, color, adornments, photograph of the clothing, close-up image of the fabric texture. Moreover, it will also record all the measurements of the garments, their cuts, lengths, widths, darts, specific stitches, etc.

The development of a database for the proposed invention system will offer a structured way to store and retrieve essential information for the transformation of garments. Thus, the database comprises:
10.1. Database Structure: A relational database management system (RDBMS) is a suitable option for the system. It allows efficient organization of data by establishing relationships between different data categories, promoting data accuracy and reducing redundancy.
10.2. Categories:
   10.2.1. Form: Divided into Tops, Bottoms, and Whole. Each garment entered into the system must be classified into one of these main categories.
   10.2.2. Subcategories: Within each main form category, there are subcategories based on the specific types of garments known in industrial pattern making. This will provide a more detailed classification.
10.3. Garment Attributes: Each garment entry in the database must have its own record, including a unique identifier or SKU (Stock Keeping Unit). The garment attributes would include:
   10.3.1. Weight: The weight of the garment in an appropriate unit (grams, ounces, etc.).
   10.3.2. Composition: The composition of the garment's fabric (for example, 100% cotton, polyester blend, etc.).
   10.3.3. Brand: The brand of the garment.
   10.3.4. Material Name: The specific name of the material used in the garment.
   10.3.5. Color: The primary color(s) of the garment. Adornments: Details about adornments, buttons, zippers, or other embellishments on the garment.
   10.3.6. Images: An image of the garment, a close-up of the fabric texture, and any other relevant images.
   10.3.7. Measurements: Detailed measurements of the garment, such as lengths, widths, positions and sizes of darts, specific stitch details, etc.
10.4. Relations: Relations established between the data entities to enhance the usability and effectiveness of the database. For example, garments can be linked to their transformation steps based on type/subtype and size.
10.5. Data Retrieval: The structure of the database will allow easy and efficient data retrieval. Users will be able to filter and search the database based on different parameters, such as garment type, color, brand, size, or material.
10.6. Data Entry: The process of adding new entries to the database will be simple and efficient. There will be a standard form or template for adding new garments to the database, ensuring that all necessary details are recorded.
10.7. Data Security and Integrity: We will implement data security measures to protect the information in the database. This will include access controls, backup and data recovery systems, and secure encryption methods.
10.8. Database Maintenance: Regular maintenance and updates will help ensure that the database remains efficient and up-to-date. This may include tasks such as removing duplicate entries, updating outdated information, and optimizing the database structure.
10.9. TRANSFORMATIONS/RECONSTRUCTION DATABASE:
This structure helps to keep the database organized and efficient, facilitating users in finding the information they need and enabling us to manage the system. We will work with database experts or data analysts to help set up and maintain the database to ensure that it operates optimally.
The data structure of the database could appear similar to the following:

### General Data Table

It includes general information of the garment, such as: Identifier, image, brand, weight, composition, construction material, color, texture, manufacturing origin, technical details, and specific markers to be identified and indexed quickly in the database.

TABLE 1
General Data Table Schema.

| | | | | | | | | | | | | | |
|---|---|---|---|---|---|---|---|---|---|---|---|---|---|
| Garment_ID | Collection | Image | Brand | Weight | Compo- | Compo- | Compo- | Material | Color | Texture | Made in | Details | Markers |
| | | | | | sition A | sition B | sition C | | | | | | |

### Design Type

In this table, information is included such as: shape, type of garment, subtype of garment, garment gender, type of collar, sleeves, center, pockets, and any other relevant characteristic that allows identifying the garment and the related design.

### Measurement Table

In this table, fields are included such as: garment size, total width, shoulder width, shoulder length, arm width, total length, front center length, back center length, front neck, back neck, neck thickness, sleeve curve, sleeve length (outer line), sleeve length (inner line), sleeve width, bastas, and any other relevant measurement regarding the garment to be considered.

### 11. Materials Table:

This element will help to understand how the type of textile will affect the possible transformations and outcomes. For example, reconstructing a lycra legging into a crop top with long sleeves will be different from reconstructing a pair of pants into a jacket.

The materials table acts as a reference guide to understand how the different types of textiles influence the process and the outcome of the garment transformations. It ensures that the reconstructive attempts match the textile properties with the desired outcome, optimizing both functionality and aesthetics. Here is a possible structure for the materials chart:

TABLE 1
Material Properties

| | | | | | | | |
|---|---|---|---|---|---|---|---|
| 1 | 2 | 3 | 4 | 5 | 6 | 7 | 8 |

Column 1: Material_ID: Unique identifier for each material.
Column 2: Material_Name: Name of the textile or material.
Column 3: Stretch Capacity: Describes the elasticity of the material (for example, Low, Medium, High)
Column 4: Durability: How resistant the material is to wear.
Column 5: Texture: The feel and appearance of the surface of the material.
Column 6: Breathability: How well the material allows air to pass through.
Column 7: Weight: Describes the heaviness or lightness of the material.
Column 8: Suggested_Transformations: Examples of transformations or reuses suitable for that particular material.

TABLE 2
Suitability of the Transformation Material

| Transformation_ID | Material_ID | Suitability_Rating | Notes |
|---|---|---|---|
| T001 | M001 | High | Great for fitted designs due to stretch |
| T001 | M002 | Low | Not suitable due to rigidity |

Column 1: Transformation_ID: Identifier of a specific type of garment transformation.
Column 2: Material_ID: Identifier of a specific material.
Column 3: Suitability_Rating: A rating that describes how suitable a material is for a particular transformation (for example, Low, Medium, High)
Column 4: Notes: Specific observations or guidelines regarding the transformation-material combination.

This structure allows you to:
i. Quickly identify the properties of different materials.
ii. Easily determine which transformations are suitable for which materials.
iii. Provide notes and guidelines to help ensure successful transformations. By using this table, anyone involved in the reconstruction process will be better equipped to make informed decisions, ensuring the longevity, functionality, and aesthetic quality of the reinvented garment.

### EXAMPLES

### Example 1—Realization of the Invention (Concept, Structure and Method of the System)

I am designing the Zero Waste garment reconstruction system that will redesign already made clothing and will teach, in simple steps, how to reconstruct unwanted garments into new ones without waste in the process. For the fashion industry and its stages of design, materials, manufacturing, and end-of-life, and for retailers (target), manufacturers, designers, brands, schools, universities, individuals, councils, and creatives. “In fact, the fashion industry has a great impact on the environment, so creating a system to reduce waste by reconstructing garments would be incredibly beneficial. Important steps that the system considers:
1. Lifecycle of a Garment: We will provide a deep understanding and documentation of the lifecycle of the garment to be reconstructed from production to disposal. This provides a comprehensive view of where waste is produced, overconsumption and pollution occur, and therefore, where there are opportunities for intervention and improvement.
2. Garment Selection: The system allows the identification and categorization of unwanted clothing based on its condition, type of fabric, and design complexity. This will help identify which clothing is suitable for reconstruction and what type of reconstruction.
3. Design Templates: A library of design templates that adapt to different types of garments and user skill levels. These templates will guide the user on how to cut, shape, and sew unwanted garments into new designs, with the aim of using as much of the original material as possible.
4. Step-by-Step Guides: Clear step-by-step guides that are accessible to users of different skill levels in the form of videos, illustrations, or written instructions.
5. Material Utilization: A guide on how to use remnants or smaller parts of clothing. This would include making smaller garments, such as small tops, underwear, and small items, or small parts of the construction of the clothing, such as pockets, collars, inner parts, etc. The objective is to leave zero waste.
6. Educational Resources: Educational content such as books and manuals to teach the system and raise awareness about the environmental impact of the fashion industry and the importance of recycling and reusing clothing.
7. Community Building: A platform for users to share their own designs and advice. This would foster a community of users who can learn from each other, share ideas, and continue innovating in the field of zero waste fashion.
8. Partnerships: Collaborations with fashion retailers, manufacturers, and designers to promote the system and provide them with tools and knowledge to implement it.
9. Workshops and Training Programs: Workshops and training programs for schools, universities, individuals, councils, and creatives to educate them about zero waste fashion reconstruction and how to use the system.
10. Technology Implementation: Use of technology to enhance the user experience. This will include AI tools and algorithms to suggest optimal ways to reuse garments based on their characteristics, or augmented reality tools that allow users to visualize the final product before beginning the reconstruction process.
11 Evaluation and Feedback: Finally, there will be a system to evaluate the effectiveness of the zero waste garment reconstruction system. This will involve tracking the amount of waste reduction achieved by users, collecting user feedback, and making periodic updates and improvements based on this feedback.
The success of the project will not only be measured in terms of waste reduction, but also in terms of how many people we inspire and empower to follow a more sustainable path in fashion.
“This system is created so that the Reuse of Deadstock or unwanted garments can be efficient, fast, and scalable, reducing the extraction of raw materials for new garments, reducing costs, and so that companies can redesign the end-of-life of their products.”
The initiative has the potential to revolutionize the fashion industry by turning a practice that is harmful to the environment into a sustainable one. With respect to the objectives, here are some specific strategies that we will consider:
i. Inventory Analysis: A crucial first step is to understand the quantity, type, and quality of dead stock or unwanted garments. This could involve an audit of inventory and storage practices. The objective would be to identify the items that are most frequently overproduced, as well as those with the greatest potential for reuse.
ii. Efficient Reconstruction Design: A database of designs optimized for reconstruction. The designs must be flexible and adaptable, with the ability to transform various types and pieces of clothing into a new garment. These reconstructed designs are easily scalable and can be achieved with minimal labor and time.
iii. Technological Integration: Implementation of technology to optimize the reconstruction process. This will include machine learning algorithms to suggest the most suitable designs for the available materials or the integration of AI.
iv. Quality Control: A robust quality control process to ensure that the reconstructed garments meet the quality standards of new clothing. This is crucial so that the garments are sellable and attractive to customers.
V. Training and Support: It will provide the necessary training to the employees and stakeholders involved in the process. This will include workshops, manuals, and support services. We will also provide ongoing support and resources to help companies maintain the system and troubleshoot any issues.
vi Supply Chain Management: It will work closely with retailers, brands, governments, and users to redesign their supply chains and end-of-life strategies for their products. This involves establishing collection points for unwanted garments, implementing recycling programs, supporting transparency in the export/import of second-hand clothing, and educating customers about the importance of sustainability in fashion.
vii. Marketing Strategy: It will market the reconstructed garments in a way that appeals to consumers. It highlights the environmental benefits and the unique nature of the garments. This will include telling stories about the garment's past life and its transformation, to make it more attractive to consumers.
viii. Economic Analysis: Show companies the economic benefits of this practice. This includes cost savings by reducing the extraction of raw materials and waste management, as well as the potential revenue from the sale of the reconstructed garments.
ix. Policy and Environmental Analysis: Projections of future environmental laws and how the implementation of the system in companies and communities will align with them.

The key to success in this effort is the creation of a system that not only benefits the environment but is also economically viable and attractive to consumers. By providing a sustainable, regenerative, and profitable alternative to traditional manufacturing practices, the system will inspire significant change in the fashion industry.

### Example 2—Software

The system will be implemented in software that will consist of the following steps

From Waste to Designs: For example, there are 500 T-shirts, size L, of dead stock from a retail brand. In the software, the garment's morphology (T-shirt) and its details (long sleeves, round neck, cuffs or bastas) are selected, then the measurements (length, width, chest width, sleeve length, armhole height, etc.) are inserted, and the software is activated to reconstruct these garments. The software will offer all the possibilities of reconstruction for these T-shirts and the resulting sizes from the transformations; for example, a skirt and top set in size M, or a dress in size M, or leggings in size S, etc. The preferred transformation is selected and the software displays in 3D design the disassembly of the T-shirt and how the pieces are repositioned to achieve the desired design without generating waste. Additionally, a technical video will be shown demonstrating how this garment is constructed, made by a person, not in 3D.

From Design to Which Waste Can Be Used: For example, a retail brand wants to design a collection of jackets and pants. Then it goes to the software, enters the desired design morphology (jacket), inserts details and measurements, and runs the software. This will show which garments need to be reused to achieve that design; for example, two pants, size S, or one short and two skirts, size M, etc.

### Example 3—Reconstruction Manual

A written manual will be developed that explains the theory of the system, the rules, formulations, mathematical reasons, and application examples with their step-by-step procedures. It will also include case studies where brands and individuals apply the system and their results, among other contents.

### Scope and Future Applications

The system and its methodologies are intended to be applied to:
Retail companies and the reuse of their deadstock or their future products in a fast, scalable, systematic, and waste-free manner.
Manufacturers: To train sewing communities with this practical tool as a sustainable update of their knowledge.
Individuals: For anyone who wishes to implement this knowledge and reconstruct their own closet.
For SMEs: Brands that wish to implement zero waste reconstruction as a specialization or a new way to offer sustainable products to their customers.
Schools/Teachers/Universities: So that this system is taught to future generations of designers.

### Example 4—Transformations

In FIGS. 25 to 27, sets of transformations that can be performed through the invention system and form part of its database are shown (FIGS. 25 to 27). In FIGS. 28 to 35, at least 8 different types of transformations that can be performed according to the proposed invention are shown, with their respective sequences of images corresponding to the “step-by-step” of each one, to carry out the transformation using the information present in the invention system's database (FIGS. 28 to 35).

### Example 5—Bases and Proportions

Another example of the rules that apply to the system is the following:
A. If we wanted to subdivide a gabardine, for example, we must assume that this garment has:
   i) LENGTH TC_{L}
   ii) WIDTH TC_{W}
B. Divide the gabardine into two pieces-upper and lower:

To simplify, we can divide the gabardine into two equal halves. This may not be the case in all practices, depending on the design of the skirt and the jacket, but it is a starting point. The proportions can be adjusted based on the desired final designs.

### Jacket (Upper Half) Dimensions:

$$iii ) LENGTH {J}_{L} = 0.5 \times {TC}_{L}$$

$$iv ) WIDTH {J}_{W} = T {C}_{W}$$

### Skirt (Lower Half) Dimensions:

$$v ) LENGTH {S}_{L} = 0.5 \times {TC}_{L}$$

$$vi ) WIDTH {S}_{W} = T {C}_{W}$$

### C. Adjustments:

It is unlikely that simply cutting a gabardine in half will produce a perfect jacket and a perfect skirt. We will have to make adjustments:
Jacket (upper half): Depending on the design of the gabardine, there may already be a waist or belt area that could serve as the hem of the jacket. It is likely that we will have to consider:
   Sleeve adjustments (shortening, tightening).
   Addition of buttons or zippers.
   Possible letting out or tightening around the waist area to give the jacket a more fitted appearance.
Skirt (lower half): The transformation of the lower half into a skirt may require:
   Adding a waistband or elastic for fit.
   Possible introduction of darts to shape it.
   Addition of closures (zippers, buttons, etc.), and shortening or altering the hem to the desired length of the skirt.

### D. Final Relation:

Given the gabardine with length TC_{L} and width TC_{W}:

### Jacket:

$${J}_{L} = 0.5 \times {TC}_{L}$$

$${J}_{W} = {TC}_{W}$$

Adjustments are necessary for the length, width, and sleeve darts.

### Skirt:

$${S}_{L} = 0.5 \times {TC}_{L}$$

$${S}_{W} = {TC}_{W}$$

Adjustments are necessary for the waist fit and the desired length of the skirt.

This formula provides a basic guide for transforming a gabardine into a two-piece set consisting of a jacket and a skirt. Adjustments and refinements will always be necessary, especially in fashion, where fit and drape play an important role in the final appearance of a garment.

### Example 6—Tables

Some examples of the tables used in the database are as follows:

### Example—General Data Table (FIG. 37)

EXAMPLE - DESIGN TABLE

| Shape | Type | Subtype | Gender type | Neck type | Sleeve | Center | Pockets |
|---|---|---|---|---|---|---|---|
| Top | Tshirt | Basic | Female | Round neck | Short sleeve | Closed | |
| Top | Jacket | Biker | Female | Classic neck | Long sleeve | crossed open | 3 |

EXAMPLE - MEASUREMENTS TABLE

| | | Shoulder | Shoulder | | | Central | Central | |
|---|---|---|---|---|---|---|---|---|
| Size | Total W | W | L | Arm W | Total L | LF | LB | Neck F |
| Small | 43.5 cms | 43 cms | 13.5 cms | 40 cms | 68 cms | 60 cms | 66 cms | 27 cms |
| | 48.5 cms | 40 cms | 14 cms | 35.5 cms | 56.5 cms | 44.5 | 49 cms | 21.5 cms |

| | | Neck | Sleeve | Sleeve L | Sleeve L | | |
|---|---|---|---|---|---|---|---|
| Size | Neck B | thick | curve | Ext | Int | Sleeve W | Hems |
| Small | 18 cms | 2 cms | 20 cms | 15 cms | 9 cms | 17 cms | 1.5 cms |
| | 17 cms | 8 cms | 24 cms | 63 cms | 45 cms | 9.5 cms | 0.7 cms |

### BRIEF DESCRIPTION OF THE FIGURES

FIG. 1. Flowchart of the proposed invention system, which comprises the user interaction platform with the database, with respect to the first transformation method. FIG. 2. Flowchart of the proposed invention system, which comprises the structure of the database and the sequence of the methodology with respect to the first transformation method. FIG. 3. Flowchart of the proposed invention system, which comprises the user interaction platform with the database, with respect to the second transformation method. FIG. 4. Flowchart of the proposed invention system, which comprises the structure of the database and the sequence of the methodology with respect to the second transformation method. FIG. 5. Example of a transformation category by Subtraction. FIG. 6. Transformation from pullover to sweatpants. FIG. 7. Transformation from two pairs of pants and one skirt to a jacket. FIG. 8. Representation of fractality in the body and the mobility of the patterns therein. FIG. 9. Similarity among arm, body, and leg patterns and how these can be interpreted as essentially the same but with differences in scale. FIG. 10. Similarity among body, arm, and leg patterns and how the curved section is essential for its reinterpretation within the body. FIG. 11. Example of realization of the Rule “Body (or trunk) is legs, and legs are trunk. “FIG. 12. Example of realization of the Rule “Body (or trunk) is arms and arms are body.” FIG. 13. Example of realization of the Rule “Legs are trunk.” FIG. 14. Example of realization of the Rule “Legs are arms and arms are legs.” FIG. 15. Example of realization of the Rule “Trunk is arms and arms are trunk.” FIG. 16. Example of realization of the Rule “Legs are arms and arms are legs.” FIG. 17. Example of realization of the Rule “Body adaptation.” FIG. 18. Example of realization of the Rule “Subdivisions. “FIG. 19. Example of realization of the Rule “Skirts as adapters for appendages: arms and legs.” FIG. 20. Example of realization of the Rule “Pants as expanders: utilizing one leg to improve width.” FIG. 21. Example of realization of the Rule “From body to hood: Reconstructing small trunks.” FIG. 22. Example of realization of the Rule “Dart mastery: transition between rectangular and curved forms.” FIG. 23. Example of realization of the Rule “Sleeve adaptation: converting rectangles into sleeves.” FIG. 24. Example of realization of the Rule “Triangular openings to create darts. “FIG. 25. Example of Transformations of the rule “Trunk is legs.” FIG. 26. Example of Transformations of the rule “Trunk is legs and legs are trunk. “FIG. 27. Example of Transformations of the rule “Legs are trunk.” FIG. 28. Transformation and step-by-step process from pants and skirt to jacket. FIG. 29. Transformation from leggings to body. FIG. 30. Transformation from pullover to sweatpants. FIG. 31. Transformation from long dress to palazzo pants. FIG. 32. Transformation from T-shirt to dress. FIG. 33. Transformation from T-shirt to dress. FIG. 34. Transformation from polar to two-piece suit A. FIG. 35. Transformation from T-shirt to two-piece suit B. FIG. 36. Example of a Conversion Table of Sizes. FIG. 37. Example of a General Data Table of the garment.

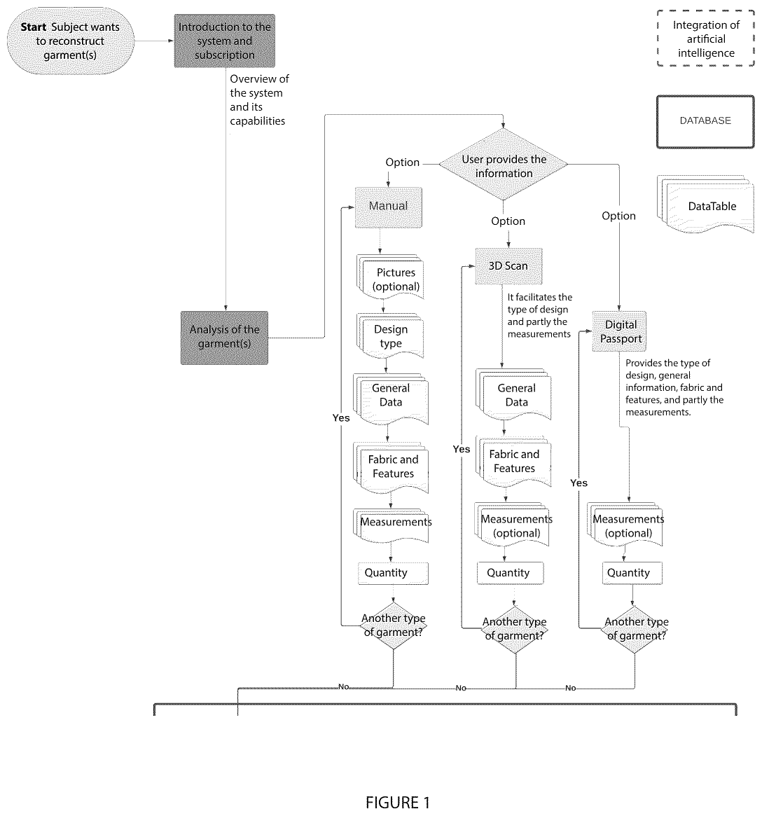

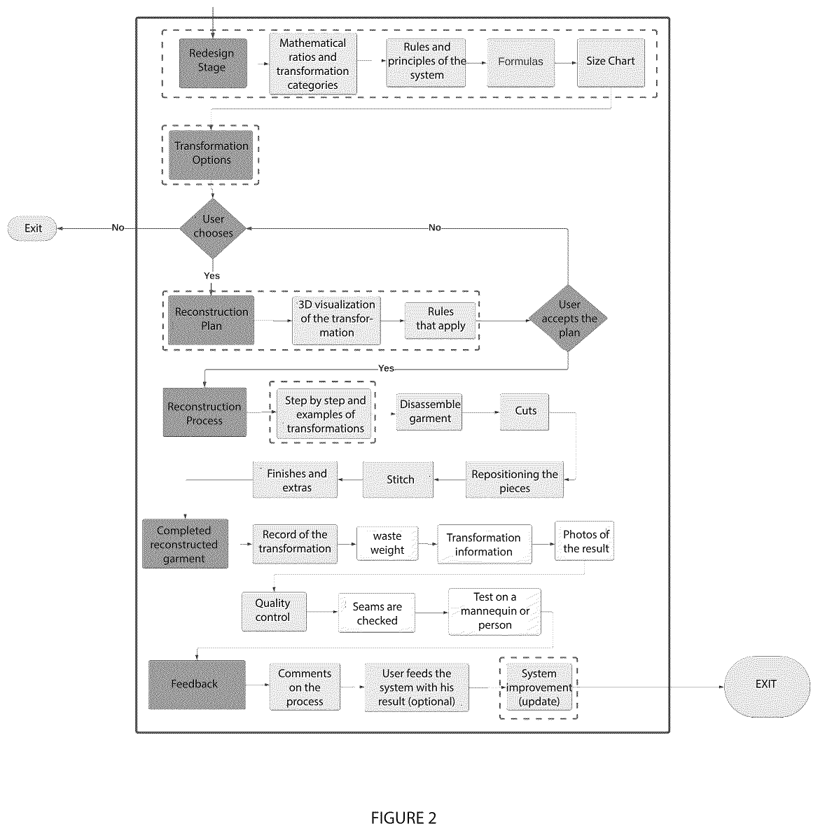

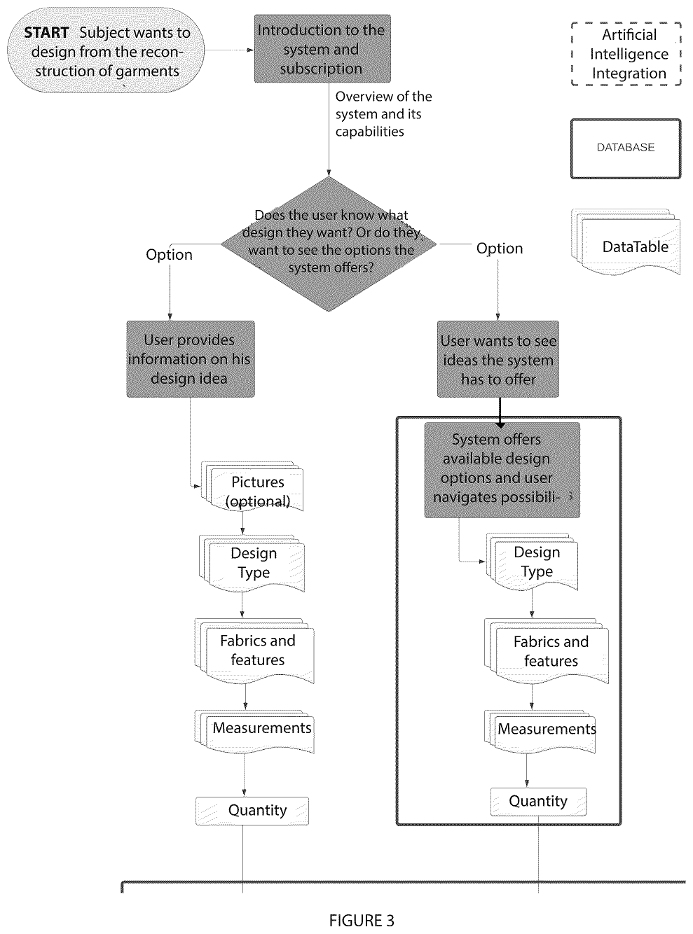

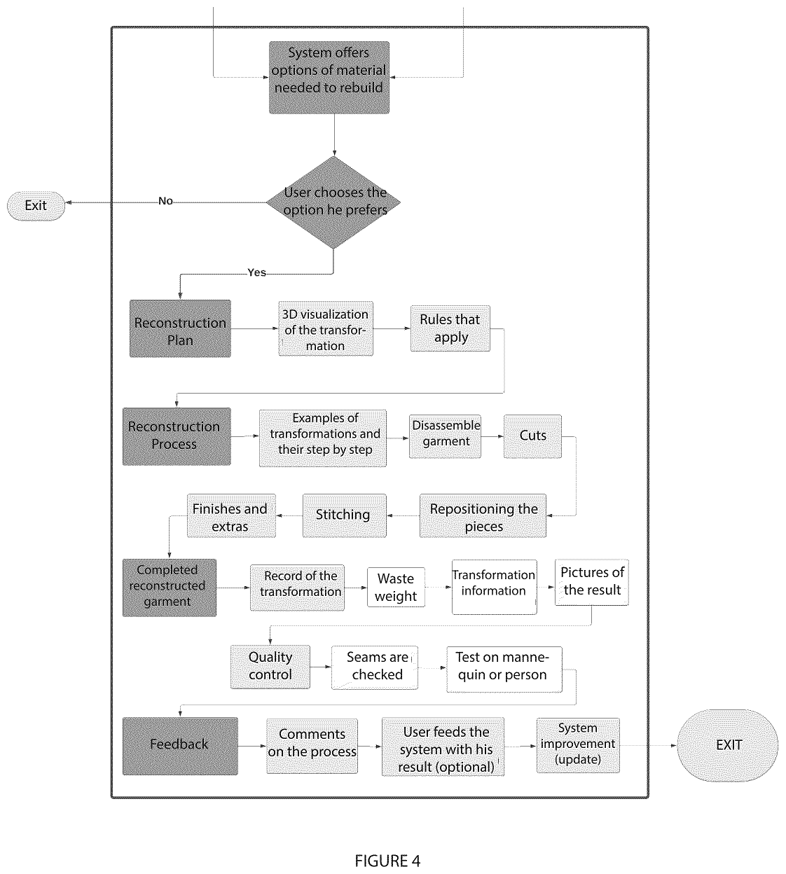

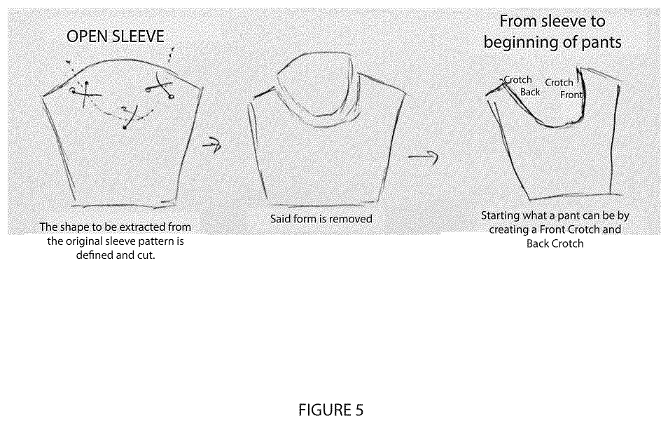

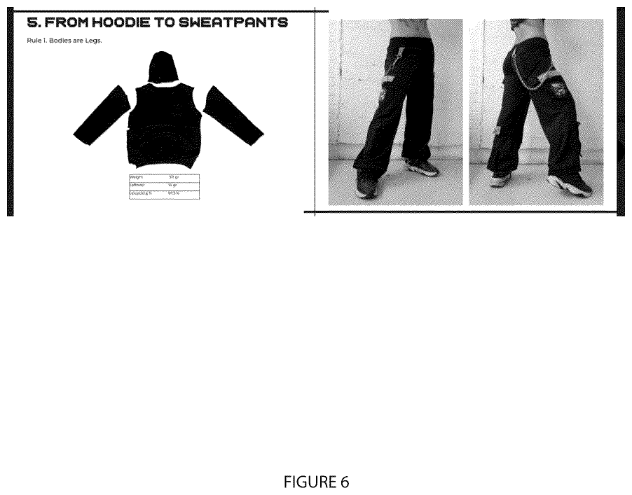

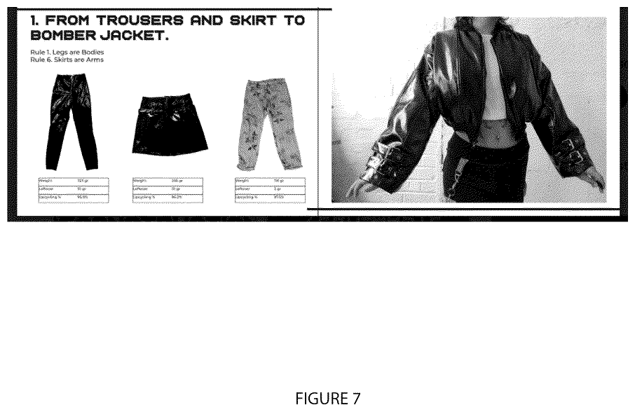

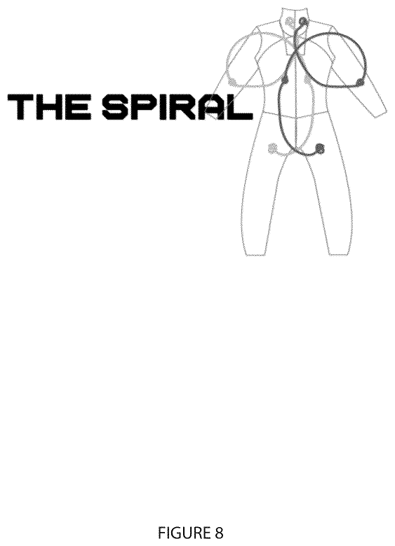

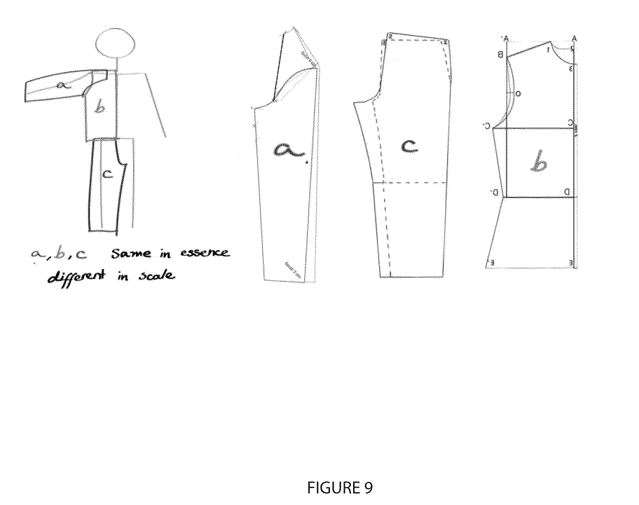

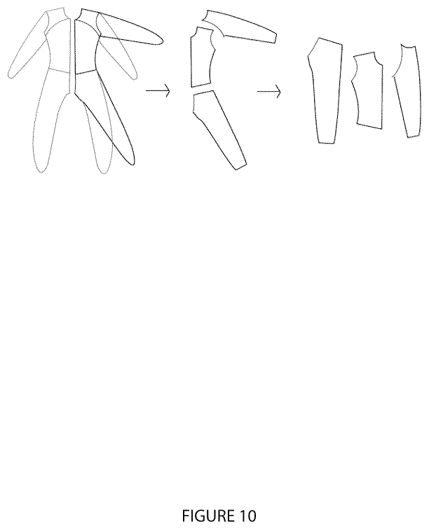

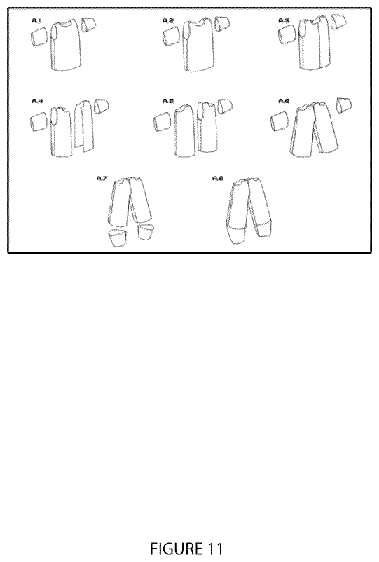

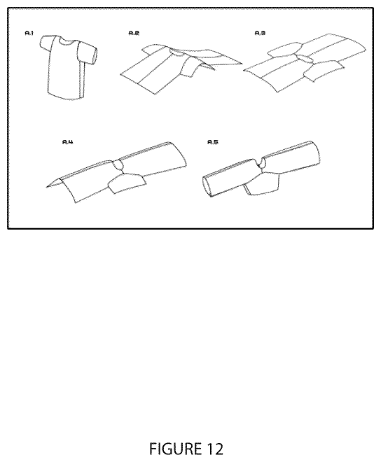

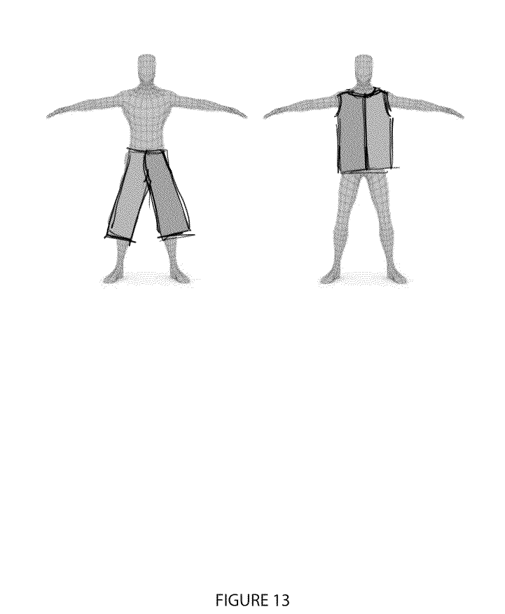

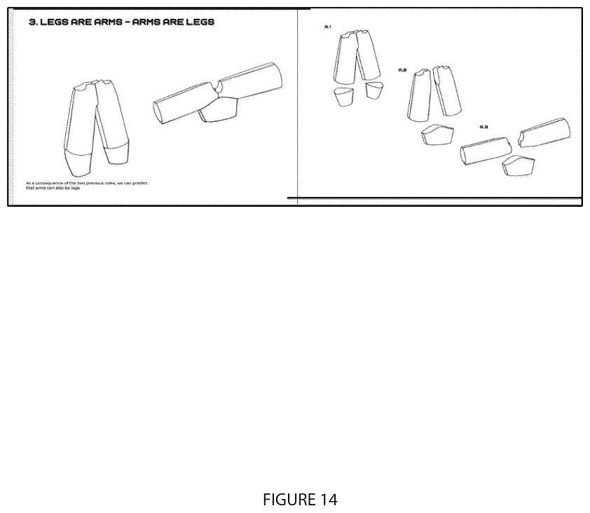

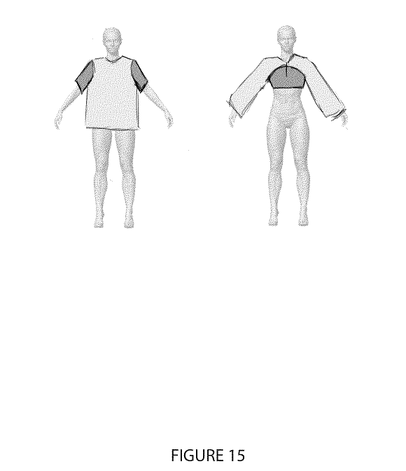

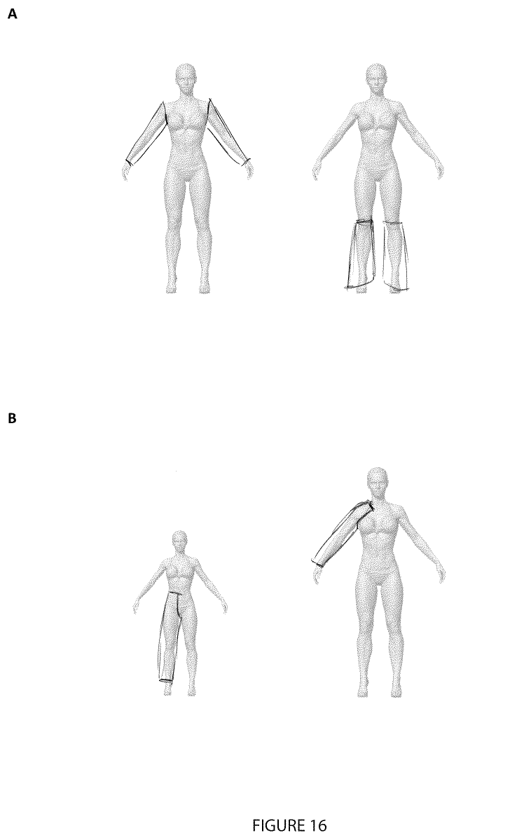

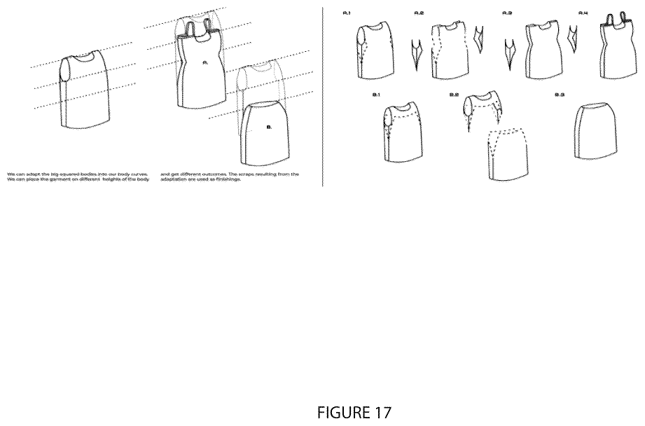

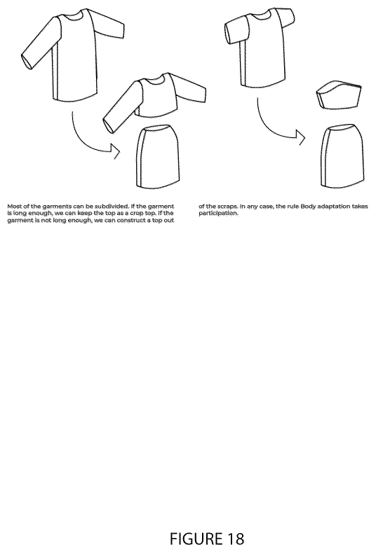

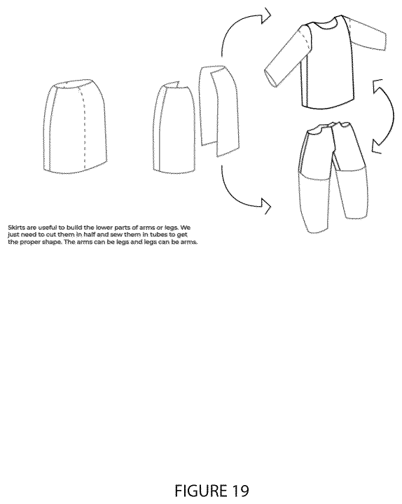

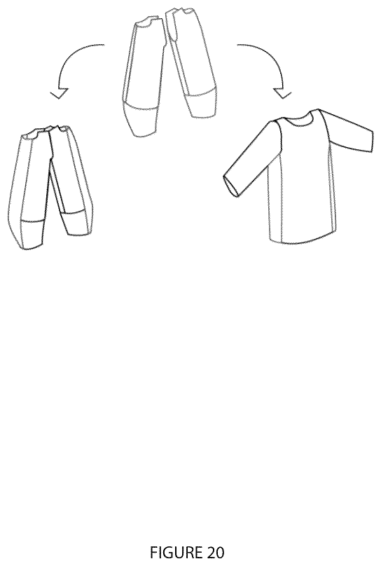

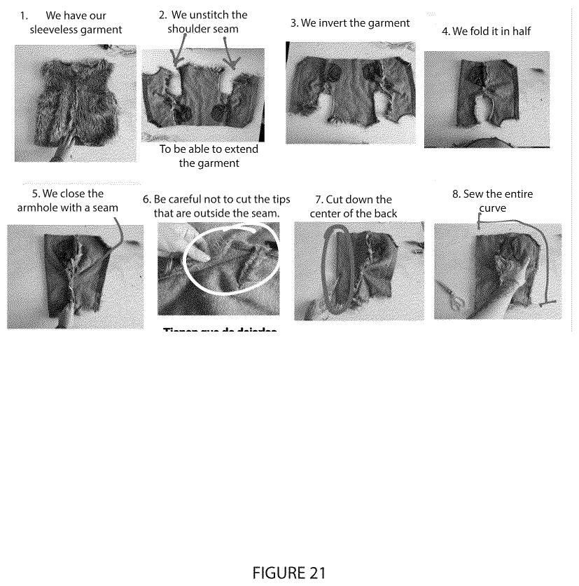

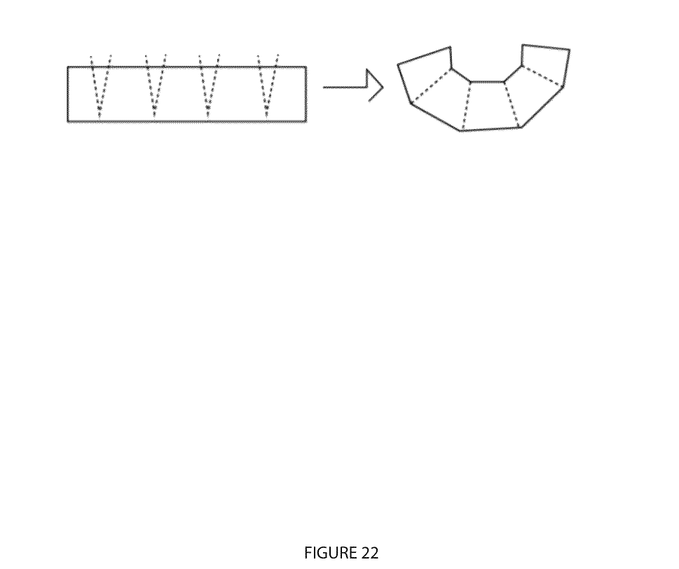

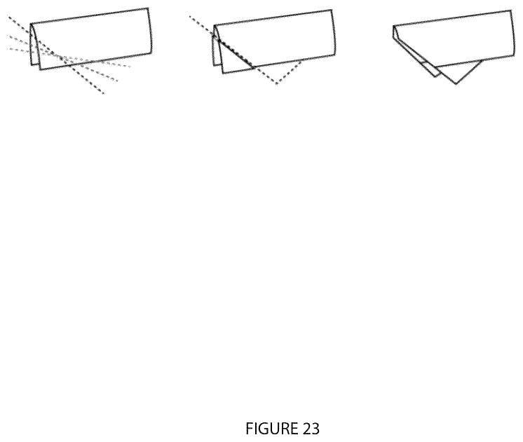

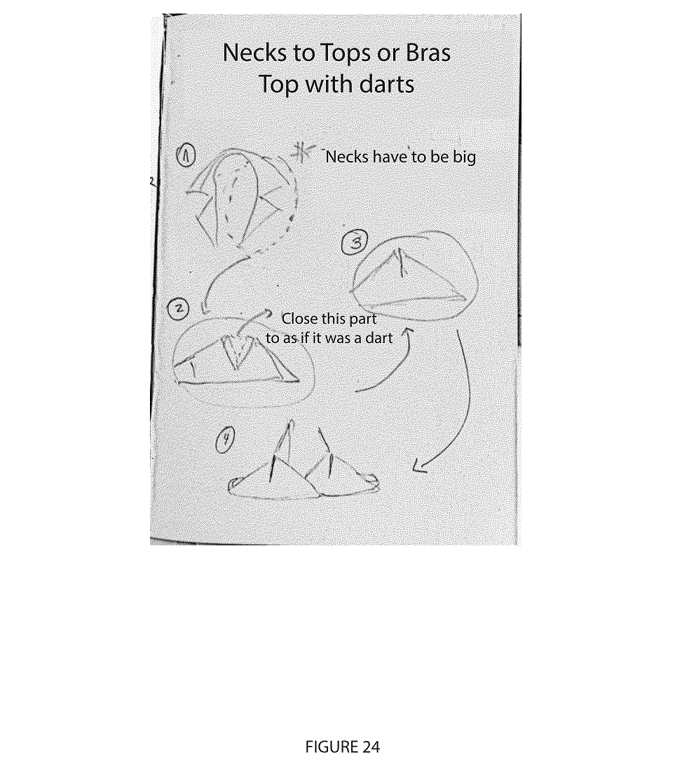

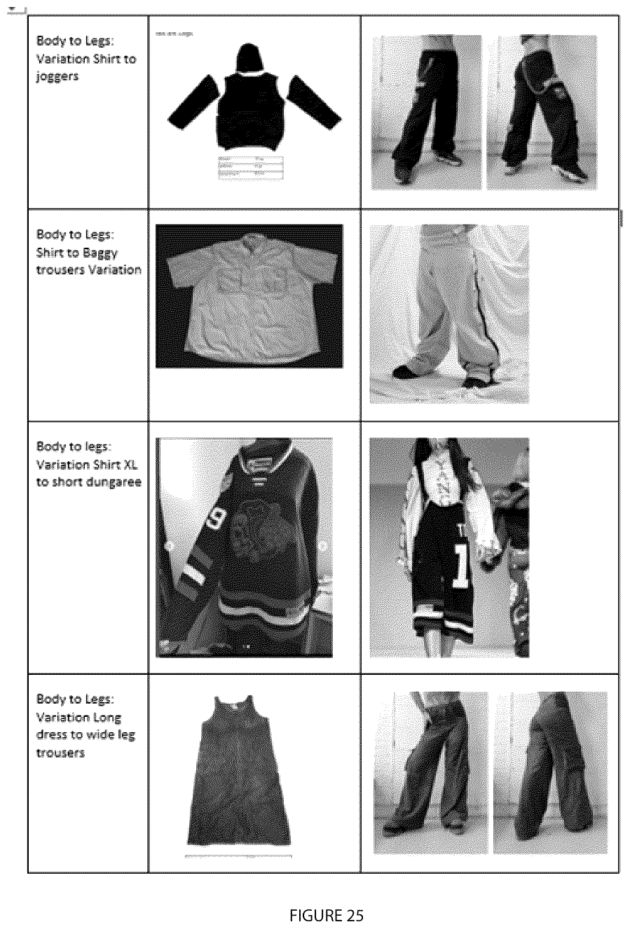

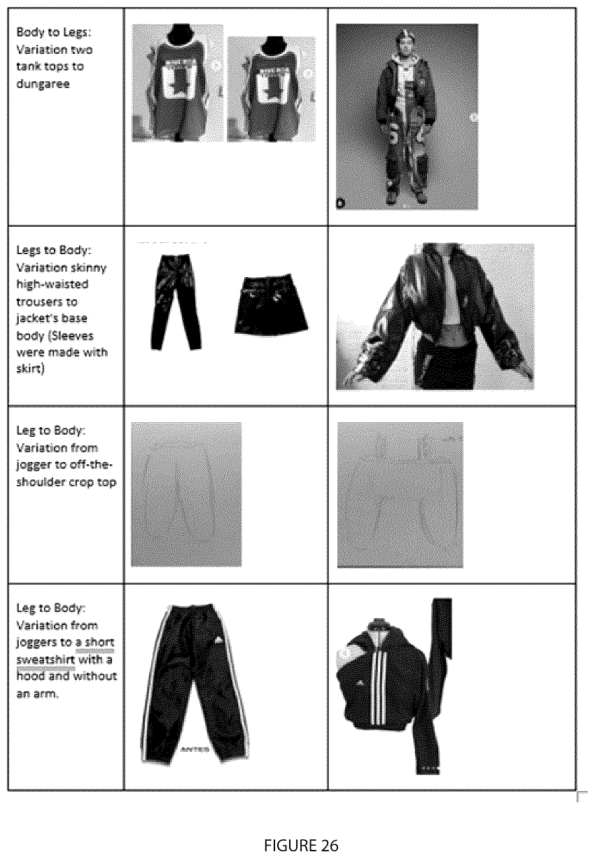

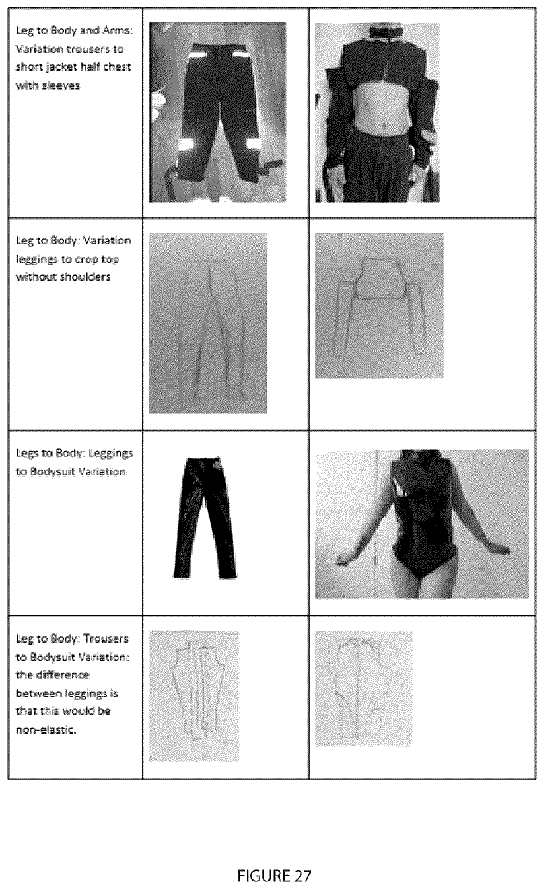

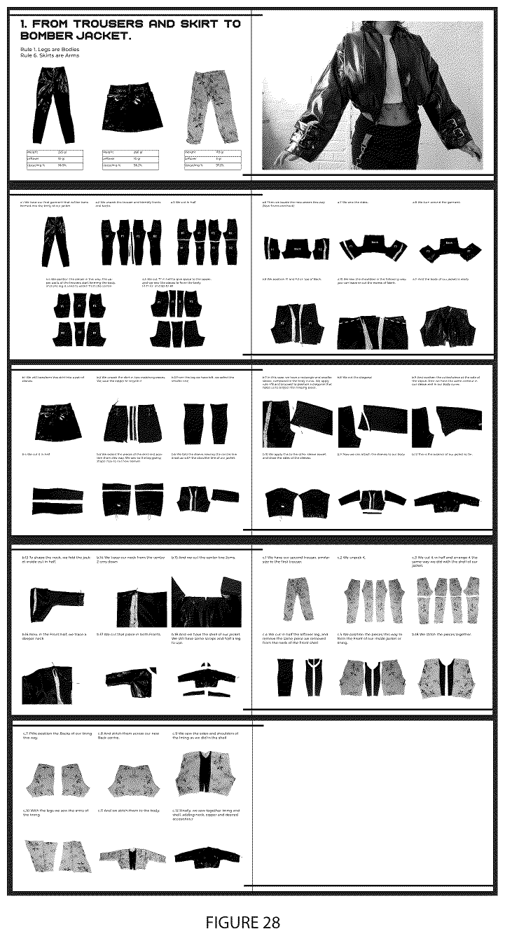

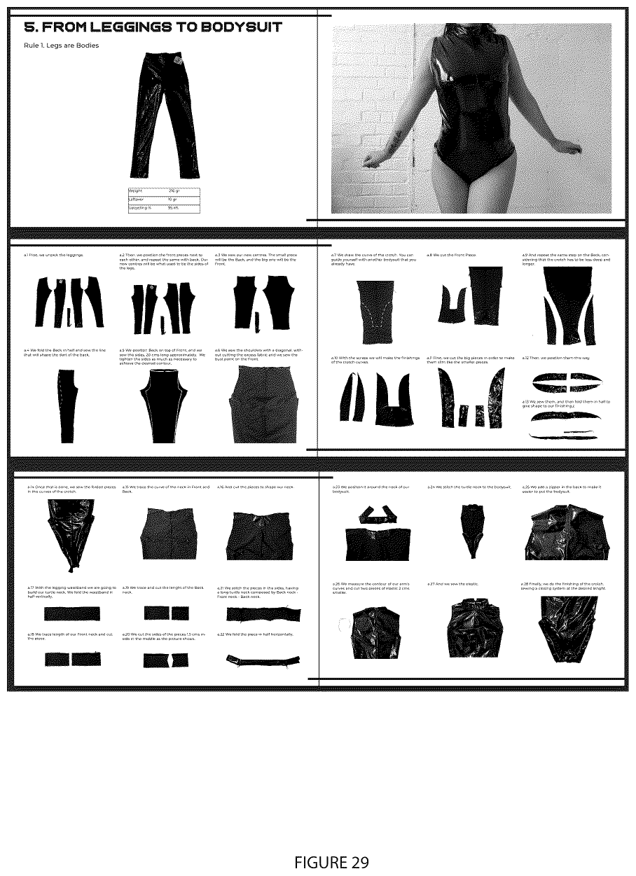

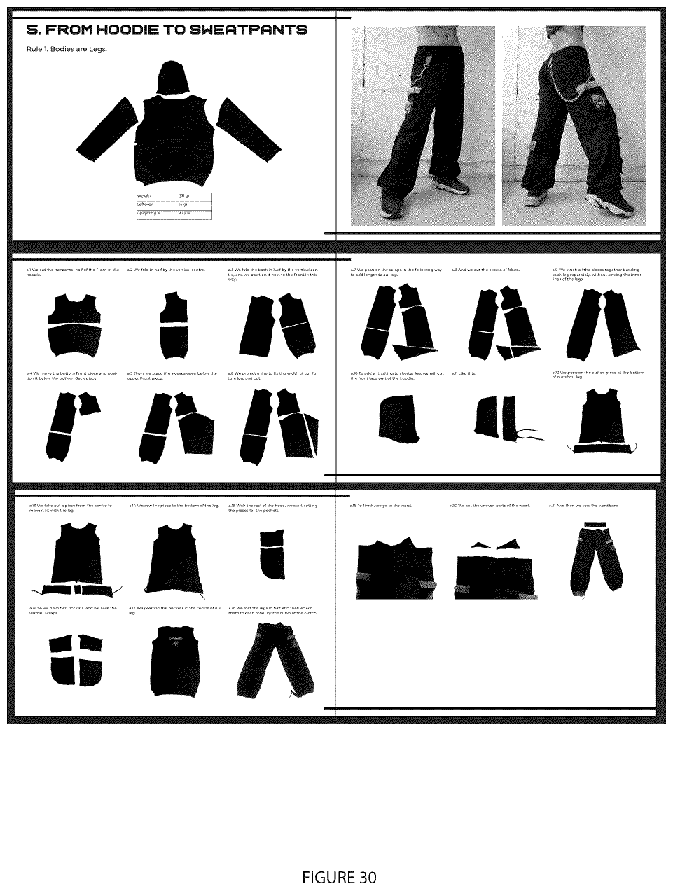

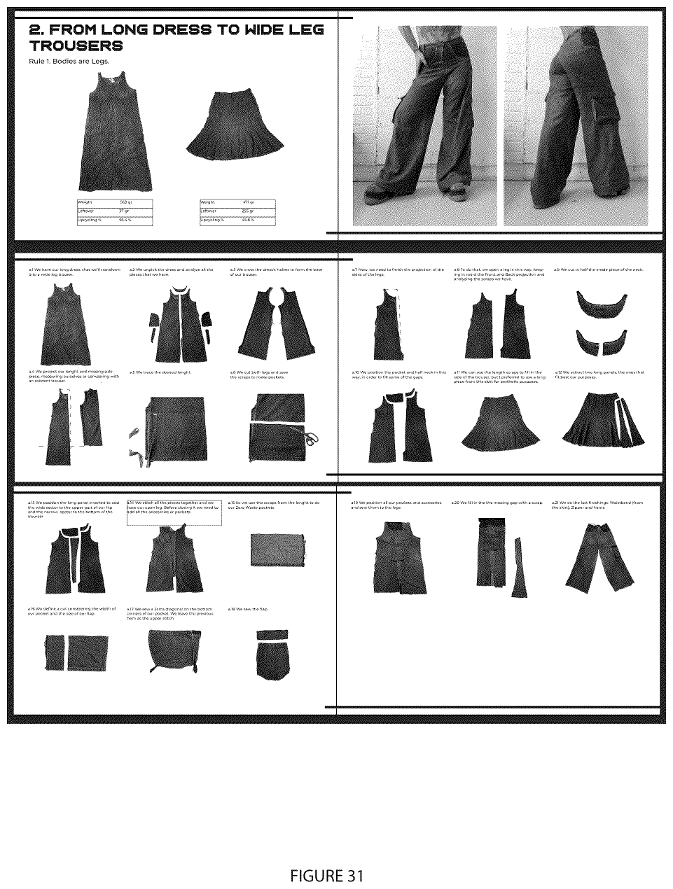

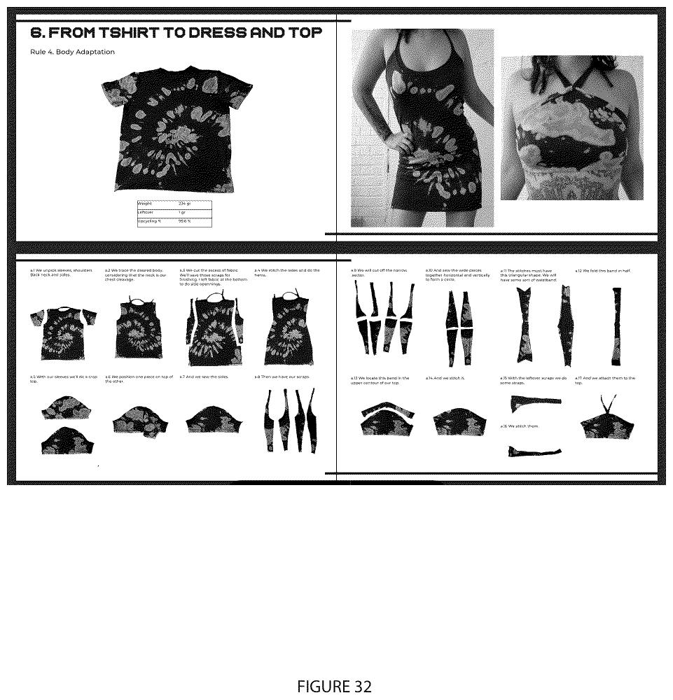

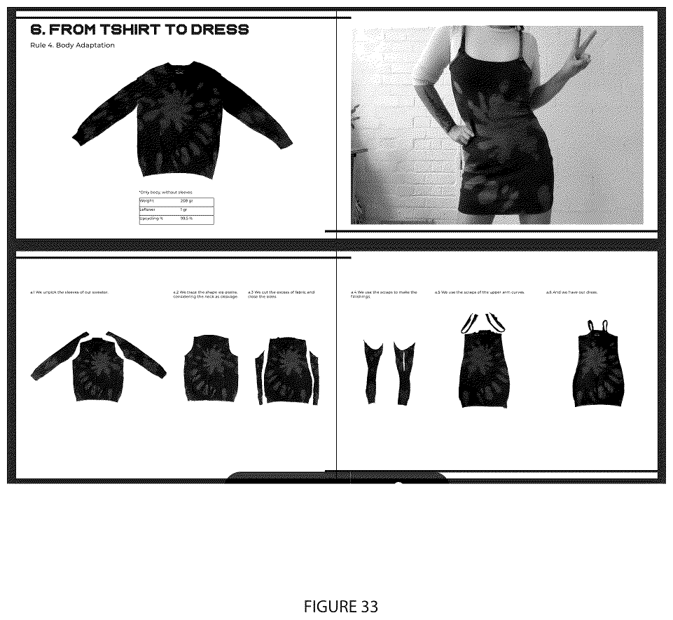

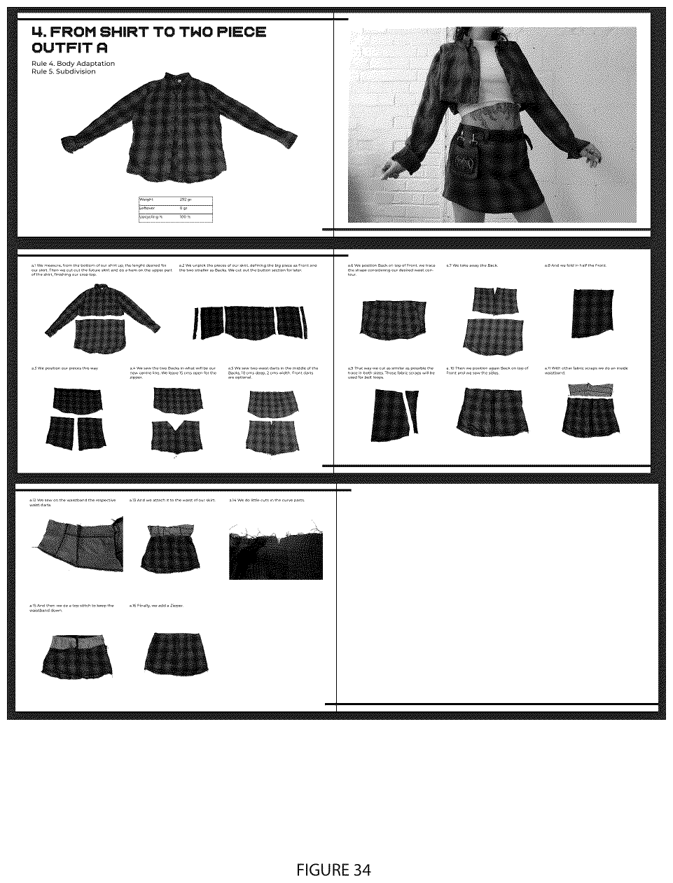

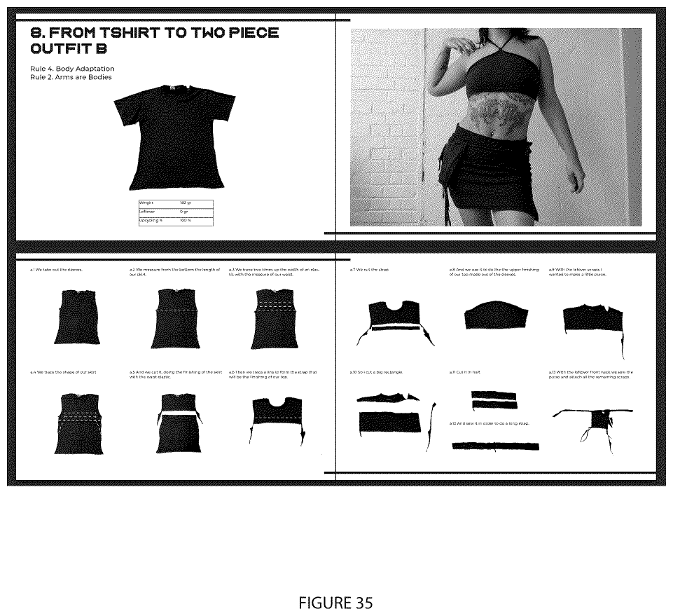

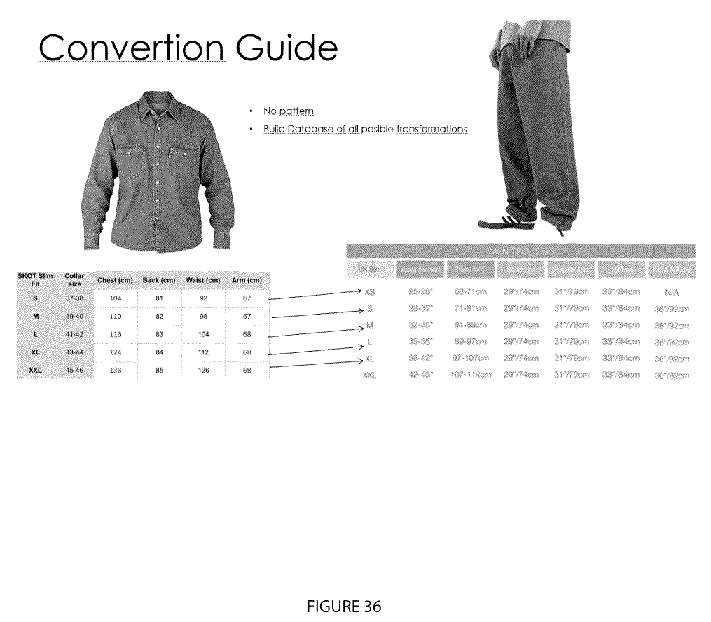

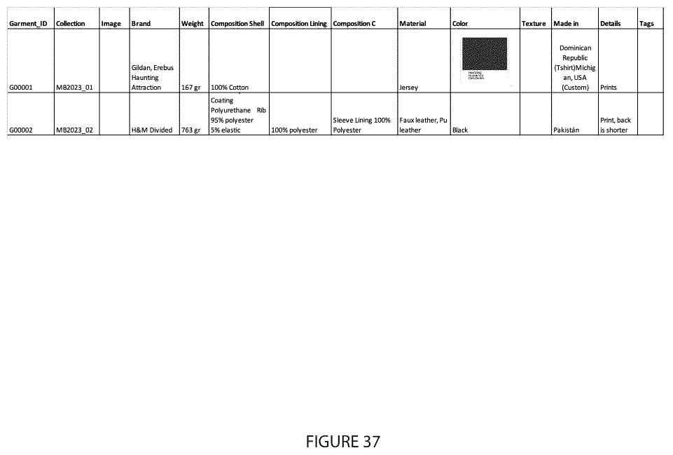

1. A standardized sustainable garment reconstruction system that does not generate waste in the transformation process by optimizing the conversion of garments from other already manufactured garments, CHARACTERIZED in that it comprises, at least:
a. A database that contains the fundamentals and rules for the transformation of garments, from already manufactured new or used garment.
b. A method for transforming an original garment into at least another garment, using at least 95% of the original garment and based on a series of parameters entered by the user, wherein said parameters, in combination with at least one rule from the list of rules for the transformation of garments of the invention, wherein the user may select a garment from the list present in the database, and wherein, after entering the parameters of the initial garment, the method provides a detailed guide of possible results so that the user may carry out the selected transformation.
c. A method for transforming at least one garment, from at least one garment which may be selected from a list comprising: dresses, pants, jackets, blouses, tops, shirts, T-shirts, pullovers, sweatshirts, windbreakers, leggings, any manufactured garment, and any combination thereof, wherein the method allows selecting one or a set of possible transformations present in the database and in combination with the set of rules of the invention, so that the user may choose which garment to manufacture, using at least 95% of the original garment(s) in the transformation.
d. Any of the methods of the invention, wherein the user may be a natural person, an artificial intelligence, or alternatively an automated selection software, which allows carrying out the method of the invention in an automated manner or as part of an industrialized mass production system.

2. The system of claim 1, CHARACTERIZED in that it comprises the incorporation of new designs into the database, wherein once entered into the corresponding category, the system will allow the user to adapt the set of rules of the invention and associated methodologies to transform an original garment into the new design. Alternatively, the invention system will allow instructing the user as to which garments may be necessary to carry out the transformation of said garments, until the new design is obtained, entered, and added to the system.

3. A standardized sustainable garment reconstruction system that does not generate waste in the transformation process by optimizing the conversion of garments from other already manufactured garments, CHARACTERIZED in that it comprises at least:
a. A dynamic and integrative database, which contains: information on garments; tables with parameters of the different garments; information on the methods for transforming garments; images related to the transformations of garments; methods for transforming garments; audiovisual information and supporting material for the user to carry out a garment transformation; algorithms and sub-databases of user information, garments, parameters, images, and information provided by the user, to train predictive models that feed the original database;
b. A user interaction platform with the database, which allows the user to enter and review information related to the transformation of a garment;
c. A method for performing the transformation of a garment entered by the user, according to the transformations present in the database, wherein the method allows reusing at least 95% of the original garment;
d. A method for performing the transformation of a garment selected by the user based on the information present in the database, according to the transformations present in said database, wherein said transformation allows for utilizing at least 95% of the material of the original garment by converting it into the new garment.

4. The system of claim 1, CHARACTERIZED in that, moreover, the database comprises at least:
i. A categorization of the garment, including: Garment Categories, Garment Attributes, and Garment Relations,
ii. A categorization of types of transformations, wherein said transformations can be selected from the list comprising:
1. Transformation by subtraction,
2. Transformation by individual reconstruction, and
3. Transformation by multiple composition.
iii. A set of transformation rules to convert one garment into a different garment, wherein each of said rules is based on the principle of body geometry, the original proportions of each segment of the original garment, and the adaptation of said patterns through the spiral factor of transposition of measures of the proposed invention, for each adaptation and transformation of the garment.
iv. A collection of images of garments, wherein said images have been grouped and categorized into groups corresponding to each of the rules mentioned in (i), to represent and teach the user step by step the transformation of a selected garment.
v. A set of explanatory manuals, which comprise the rules in (i) and the images in (ii), used for each of the transformations existing in the database.
vi. Algorithms that allow organizing the information contained in the database, performing analysis of the existing information and new information entered by the user, entering and categorizing new information into the database, performing statistics, and training predictive models to facilitate the operation of the system by new users, based on feedback from previous users.
vii. Information tables used by the system to store, categorize, and display information to the user regarding the parameters that characterize each of the garments identified in the system, wherein said tables comprise at least the following: General Data, Design Typology Table, Measurement Tables, Material Properties Table, Suitability Table for transformation material, and Conversion Size Table.

5. The system of claim 4, CHARACTERIZED in that the categorization of the garment comprises a main selection based on its Form, and a series of subcategories, wherein the categorization by Form comprises at least the following main segments: i) Tops, ii) Bottoms and iii) Whole, wherein i) “Tops” corresponds to any garment that goes on the upper part of the body, ii) “Bottoms” corresponds to any garment that goes on the lower part of the body, and iii) “Whole” corresponds to any garment that includes both the upper and lower parts; wherein moreover, each garment introduced into the system must be mandatorily classified into at least one of these main categories, and wherein the subcategories correspond to the specific types of garments known in industrial pattern making, which will provide a more detailed classification of the garment and of the transformations susceptible of being carried out from it.

6. The system of claim 4, CHARACTERIZED in that the garment attributes correspond to the attributes of each garment entry in the database, which must have its own record, including a unique identifier or SKU (Stock Keeping Unit), wherein said garment attributes comprise:
a. Weight: The weight of the garment in an appropriate unit of measurement, which may be selected from the list comprising at least: grams, ounces, pounds, and any other internationally valid unit of measurement;
b. Composition: The composition of the garment's fabric, which may be selected from the list comprising: 100% cotton, Polyester, Silk, Wool, synthetic material, natural material, and any combination thereof;
c. Brand: The brand of the garment;
d. Material Name: The specific name of the material used in the garment;
e. Color: The principal color(s) of the garment;
f. Embellishments: Details regarding embellishments, buttons, zippers, and any other adornments on the garment;
g. Images: An image of the garment, a close-up of the fabric texture, and any other relevant image;
h. Measurements: Detailed measurements of the garment, such as lengths, widths, positions and size of darts, specific stitch details, and any other appropriate reference measurement.

7. The system of claim 4, CHARACTERIZED in that the Garment Relations comprise relationships established among the data entities to improve the usability and effectiveness of the database, including, but not limited to: garment type, garment subtype, garment size, bases and proportions of the garment, and garment transformation relations.

8. The system of claim 7, CHARACTERIZED in that the relationship of the garment proportions comprises the following proportions:
a. Width Relationships, wherein:
i. Trunk circumference≈circumference of 2 legs (or) circumference of 2 arms, and
ii. Leg circumference≈circumference of one arm.
b. Relationships based on width (circumference), wherein the trunk width is approximately equivalent to the combined width of two legs or two arms, and wherein the width of one leg is approximately equal to the width of one arm; corresponding to the above, let T=Trunk Width, L=Leg Width, A=Arm Width, which corresponds to the following relationships:
$$T \approx 2 L ;$$
$$T \approx 2 A ; and$$
$$L \approx A .$$
c. Length Relationships:
$$i . Trunk length + extra length \approx leg length . \\ ii . Leg length > arm length . \\ iii . Trunk length \approx arm length .$$
d. Relations based on length, wherein the trunk length is less than the leg length, the trunk length is approximately equivalent to the arm length, and the arm length is less than the leg length; corresponding to the above, let TL=Trunk Length, LL=Leg Length, AL=Arm Length, which corresponds to the following relations:
$$TL < LL ,$$
$$TL \approx AL , and$$
$$AL < TL .$$
e. Other Relations, wherein by predefining body=C, leg=P, and arm=B, the following relations are obtained:
$$i . C = P = B for the base theory , but conditioned by sizing , \\ ii . lC = 2 ( P - l ) , where l = difference in length between body and leg ;$$
and
iii. Jacket (upper half) Dimensions:
$$iii ) LENGTH {J}_{L} = 0.5 \times {TC}_{L}$$
$$iv ) WIDTH = {J}_{W} = {TC}_{W}$$
iv. Skirt (lower half) Dimensions:
$$v ) LENGTH {S}_{L} = 0.5 \times {TC}_{L}$$
$$vi ) WIDTH {S}_{W} = T {C}_{W}$$
wherein these relations collectively support that: i) The trunk, when opened, can approximately match the combined widths (circumferences) of two legs or two arms, ii) A single leg, in terms of width, is somewhat similar to an arm, but is longer; and iii) The length of a trunk is approximately equal to the length of an arm; all of which reinforces and enables the creation of a system of interrelations among the different sections of the garment, thereby allowing various possibilities for reconstruction based on the original dimensions of the garment.

9. The system of claim 7, CHARACTERIZED in that the garment transformation relations correspond to the following:
a. 1:1 (One garment into one garment): wherein it refers to the use of techniques to transform one garment into another, with minimal or no waste, including deconstructing and completely remaking the garment.
b. 1:2 (One garment into two): wherein it shows users how to divide a single garment into two separate pieces, which is useful for transforming larger garments into smaller ones, or for creating matching sets.
c. 3:1 (Three garments into one): wherein it refers to the use of techniques in the process of combining three different garments into one, which allows mixing and matching different parts of each garment to create a new and unique piece.
d. 1: 1/x (One garment into fractions): wherein it shows how to divide a garment into several parts that can be used separately, which allows creating accessories or using the fabric in other sewing projects.

10. The system of claim 4, CHARACTERIZED in that the set of rules comprises at least the following: Trunk transformations; Leg transformations; Arm transformations; Body adaptation; Subdivisions; Skirts as adapters for appendages, wherein said appendages correspond to arms and legs; Pants as expanders, wherein one leg is utilized to improve width; From body to hood: Reconstructing small trunks; Dart mastery: transition between rectangular and curved forms; Sleeve adaptation, wherein said adaptation allows converting rectangles into sleeves; Interchangeability of 3D curved forms; Triangular openings to create darts

11. The system of claim 4, CHARACTERIZED in that the set of explanatory manuals comprises audiovisual material including, in turn, videos and images, documents, recorded classes and/or any instruction relating to adequately explaining a specific transformation that forms part of the system.

12. The system of claim 4, CHARACTERIZED in that the Material Properties Table comprises at least eight columns, wherein each column corresponds to a specific type of parameter, and wherein the parameters that compose this table correspond to the following:
a. Column 1: Material_ID
b. Column 2: Material_Name
c. Column 3: Stretch Capacity
d. Column 4: Durability
e. Column 5: Texture
f. Column 6: Breathability
g. Column 7: Weight:
h. Column 8: Suggested_Transformations
wherein column 1 refers to a unique identifier for a specific material; wherein column 2 refers to the name of the textile or material; wherein column 3 describes the elasticity of the material, wherein, moreover, said elasticity may be categorized into the levels selected among: Low, Medium, and High; wherein column 4 refers to the inherent resistance of the material to wear; wherein column 5 refers to a description regarding the feel and appearance of the surface of the material;
wherein column 6 refers to the permeability of the material with respect to air; wherein column 7 describes the lightness of the material; and wherein column 8 refers to examples of transformations or reuses suitable for that particular material.

13. The system of claim 4, CHARACTERIZED in that the Transformation Material Suitability Table comprises at least four columns, wherein each column corresponds to a specific type of parameter, and wherein the parameters that compose this table correspond to the following:
a. Column 1: Transformation_ID
b. Column 2: Material_ID
c. Column 3: Suitability_Rating
d. Column 4: Notes
wherein column 1 refers to an identifier for a specific type of garment transformation;
wherein column 2 refers to a unique identifier for a specific material;
wherein column 3 refers to a rating that describes the suitability of a material for a specific transformation, wherein, moreover, said rating may be categorized among the following levels: Low, Medium, and High; and
wherein column 4 refers to any observation or specific guidelines regarding the transformation-material combination.

14. The system of claim 4, CHARACTERIZED in that the Conversion Size Table is an element of the invention that allows identifying and estimating the size of the garment to be obtained according to the size of the original initial garment being reconstructed, based on the zero-waste transformation (rule) chosen by the user, wherein said Table further provides users with a guide to help them understand how the size of the original garment can affect the size of the reconstructed garment, depending on the type of transformation chosen, including at least the following parameters:
a. Original garment size,
b. Type of transformation,
c. Resulting garment size,
d. Notes and adjustments
wherein, furthermore, said Table contains both default values provided by the database as well as values entered by the user, which are used as elements of discrimination and selection with respect to the viability of the desired transformation, as well as the type of transformation susceptible to being performed.

15. The system of claim 13, CHARACTERIZED in that each of the parameters present in said Tables is evaluated and weighted by the system to determine whether it is possible to perform the transformation of the garment initially selected by the user, and subsequently to present the user with a list of options and/or available transformations to be performed, if applicable.

16. The system of claim 3, CHARACTERIZED in that the transformation method in (c) corresponds to a first selection method that allows the user, through the system's platform, to enter the data of a particular garment to be converted, so that the system can propose a series of possible transformations or, once the user has decided to perform a desired configuration or transformation based on their garment, the system can indicate whether such transformation selected by the user is viable. In the event that it is viable, the system will provide and guide the user through a series of steps, which further include guides, manuals, a sequence of images, instructions, and recommendations, so that the user can perform the desired transformation; finally, the system will collect information corresponding to the performed transformation to evaluate and validate the transformation, the effectiveness and/or efficiency of the process, as well as any other parameter necessary to determine the success of the process.

17. The system of claim 3, CHARACTERIZED in that the transformation method in (d) corresponds to a second method applicable in the case that the user is not clear about which garment they wish to convert or transform, but is clear about the target garment they wish to obtain; wherein said method allows guiding the user in the selection of the target garment or final garment to be obtained, and once confirmed by the user, the system will further provide the user with a series of probable and viable options to obtain said garment from different initial garments to be transformed. Once the user has decided and selected which will ultimately be the initial garment to use to obtain the desired result, this second method will guide the user using the system's resources, including the information and components in the database, to provide a step-by-step guide to carry out the desired transformation. As in the method described above, the system comprises a transformation evaluation process, which will allow incorporating the results and parameters into the system to modify and improve the transformation processes, using the user's feedback and the performance of the process.

18. The system of claim 1, CHARACTERIZED in that any of the transformation methods comprises at least the following steps:
a. Initial Images (PHOTOS BEFORE): wherein clear and well-lit images of the original garment are obtained, the initial garment is shown from multiple angles in order to provide a complete view of the starting point. This will provide a visual reference of how the garment looked before the transformation process,
b. Weight Measurement: wherein the original garment is weighed and its weight is recorded in the system, wherein, moreover, this step is crucial for calculating the upcycling percentage later,
c. Deconstruction Process: wherein the garment is disassembled into its identified essential patterns, the process of what is necessary to undo from the original garment is documented, including audiovisual material, photographs and/or videos that show how to carefully remove the stitches and separate the garment into its constituent parts,
d. Cutting Process: wherein the process of cutting the pieces of the garment is documented according to the proportions and rules of the respective selected transformation, as well as including supporting audiovisual material to help users follow the process,
e. Sewing Process: wherein, once the pieces are ready, the process of sewing them together again according to the manual or guide corresponding to the previously selected transformation is documented to create the new garment, wherein, moreover, this comprises the use of audiovisual material provided by the system, which includes photographs or videos to provide clear step-by-step instructions for the present process,
f. Final Result: wherein the completed garment is shown, including the capture of images from multiple angles and the entry of these images into the system for evaluation and validation of the success, as well as the performance of the process, including any important detail or feature of the new garment,
g. Final Weight Measurement: wherein the completed garment is weighed and its weight is recorded,
h. Calculation of the Upcycling Percentage: wherein the upcycling percentage is calculated by comparing the weight of the completed garment with the weight of the original garment, wherein, moreover, this will provide an estimation and/or evaluation of the performance and the percentage of success of the process, with respect to how much of the original material was used in the transformation process,
i. Lifecycle of the New Reconstructed Design: wherein a study and analysis is performed on the impacts and consumption that this new design had in terms of energy used and CO₂ emissions.
